(19) United States
(12) Patent Application Publication
(10) Pub. No.: US 2022/0217994 A1
(43) Pub. Date: Jul. 14, 2022

(54) NATIVE EDESTIN PROTEIN ISOLATE AND USE AS A TEXTURIZING INGREDIENT

(71) Applicant: Steuben Foods, Inc., Elma, NY (US)

(72) Inventor: Cheryl Mitchell Ellis, Orchard Park, NY (US)

(73) Assignee: Steuben Foods, Inc., Elma, NY (US)

(21) Appl. No.: 17/551,163

(22) Filed: Dec. 14, 2021

Related U.S. Application Data
(60) Provisional application No. 63/124,973, filed on Dec. 14, 2020.

(51) Int. Cl. A23J 1/14; A23J 3/14; A23J 3/26

(52) U.S. Cl. CPC A23J 1/142; A23J 3/26; A23J 3/14

(57) ABSTRACT

A process and product that solves the problems with regard to hemp protein isolation, raw material input preparation, and processing of the raw material input, in order to produce a superior hemp protein meat and dairy analog. The composition and process include a process for hemp grain protein isolation, pasteurization, formation of a liquid solution, gel formation, texturization and meat and dairy analog production. The process of the present disclosure results in a structured protein food product, or meat analog, having superior properties when compared to existing products or similar products manufactured using known technology.

### CROSS REFERENCE TO RELATED APPLICATIONS

This patent application claims the benefit of U.S. Prov. Pat. App. Ser. No. 63/124,973 filed Dec. 14, 2020, which is incorporated herein.

### FIELD

This disclosure relates to protein isolation and plant based meat and dairy analogs, more particularly to plant based products having the texture, appearance, and taste of meat or dairy products. This disclosure also relates to compositions and methods for preparing a liquid, gel or solid product for use in meat and dairy analog production.

### BACKGROUND

Hemp based meat or dairy analogs, produced using only hemp grain as a protein source, are not known to be commercially available and have not been described in food industry or food science literature. For use in food products, hemp protein is thought to be inferior to soy and pea protein, particularly with regard to properties required for the production of meat and dairy analogs. Meat and dairy analogs, which may also be referred to herein as structured protein food products, require proteins capable of forming a strong gel matrix, and hemp protein has not been found to have strong capability in that regard.

According to Wang, the “emulsifying and gel-forming properties of hemp protein are found to be generally inferior to those of soy protein.” (Wang et al, 2019). While Malomo showed that salt micellization isolation of hemp protein can improve its gel forming capability, Shen discloses that this complex, costly and time consuming method of protein isolation negatively impacts protein structure, and that chemical crosslinking agents may be required for sufficient gel forming capability in hemp protein. (Shen et al., 2021; Malomo et al, 2014; Wang et al., 2019).

As indicated by Wang, soy protein is currently favored over hemp protein for production of meat analogs. “Currently, mostly soy proteins are used to mimic animal proteins because of their favorable gelling properties and the resulting creation of an interlaced, fibrous matrix.” (Schreuders et al., 2019). The latter fibration of soy occurring at typical temperatures of 130° C. (266° F.). For example, IMPOSSIBLE FOODS uses soy protein in its IMPOSSIBLE BURGER. Due primarily to health and nutrition-related concerns about soy products, however, BEYOND MEAT, the largest competitor for IMPOSSIBLE FOODS, uses yellow pea protein in its BEYOND BURGER. Yellow pea, however, “has a much lower gelling capacity than soy protein” and “heat induced gels of soy protein isolate (SPI) are stronger than heat induced gels of pea protein isolate (PPI).” (Schreuders et al., 2019).

While soy and pea protein have known taste, texture and phytochemicals limitations as a protein source for meat and dairy analog production, no successful plant based alternative protein replacement has yet been found for meat analogs. Hemp protein, however, has been investigated as a potential substitute for soy protein in meat analogs. Recently, Zahari reported that, while hemp protein has been recognized for its superior nutritional and functional properties, it had not yet been used in meat analog production. “Previous works have shown that hemp seed protein in particular, has a high protein quality and functionality. However, no study uses hemp seed protein as a raw material for meat analog production.” (Zahari et al, 2020).

Zahari went on to demonstrate that hemp protein concentrate (HPC) could be used in combination with soy protein isolate (SPI) to produce a meat analog by conventional extrusion, but not as a sole source of protein. The study concluded that, “HPC could therefore be a promising novel material to be included into extruded products and this study shows that the resulting meat analog gave a comparable texture to SPI alone, and that soy protein could be substituted by hemp protein by up to 60%.” (Zahari et al, 2020). With regard to the use of higher concentrations of hemp protein in the formulation, the study showed that this resulted in unacceptable decreases in hardness and chewiness in the meat analog product. Thus, Zahari, Wang and Shen teach away from the use of hemp protein as a sole protein source in meat analog production.

Despite the need for new and improved sources of plant protein to meet the growing demands of the plant based food industry, hemp protein has not yet achieved significant market share in food production. Soy and pea protein continue to dominate the plant based food market, despite the nutritional and environmental advantages of hemp. Soy and pea protein benefit from decades of study and wide commercial availability and use, in meat analog production and other food products, has resulted in great improvements in ingredient and product quality and cost benefits in scale.

Improvements in soy and pea-based meat analogs have come through extensive research and development in all stages of meat and dairy analog production. Meat analog production generally involves four steps. The first step involves protein isolation from a selected plant material. The second step involves combining the isolated protein with water and oil to form a matrix for thermal gelation or extrusion. The third step involves thermal gelation or extrusion of the raw material to set and texturize the protein. The final step is using binders and water binding agents such as carrageenan, cellulose fibers, starch, gluten, or flours to form a meat analog product that may then be cooked to simulate products such as hamburger, filets, chicken pieces and pulled pork.

The first step of meat analog production involves protein isolation from a plant material. Conventionally, soy and pea protein are use as plant material for protein isolation. Hemp grain protein, however, has excellent digestibility and desirable essential amino acid composition and has been considered as a possible source of protein for meat analogs (Tang, Ten, Wang, & Yang, 2006; Wang, Tang, Yang, & Gao, 2008; Russo and Reggiani, 2015a; Callaway, 2004; House et al., 2010; Docimo et al., 2014; Zahari et al., 2020). A recent proteomic characterization of hemp grain concluded that hemp grain is an underexploited nonlegume, protein-rich grain (Aiello et al., 2016).

While the nutritional potential of hemp proteins is high, the nutritional quality of plant proteins, as measured by their amino acid composition and digestibility, is influenced by numerous factors. The amino acid composition may be influenced by genotypic variability or agronomic conditions such as soil fertility and postharvest processing that alters the ratio of grain components (e.g., hulling). The digestibility of proteins may be affected by protein structure and the presence of antinutritional compounds in the plant material or formed during alkaline or high temperature processing (Sarwar, 1997). Aiello, however, found that antinutritional factors including condensed tannins, phytic acid and trypsin inhibitors are present in low concentrations in hemp grain (Aiello et al., 2016).

Functional characteristics of hemp protein have hindered its use as a protein source in food products. Hemp protein concentrates commercially have been available as the result of hemp seed oil production. Hemp seeds after being milled and pressed for the lucrative oil, result in a protein rich seed cake. The seed cake is green in color, high in fiber and represents a protein concentrate of about 40%. Unfortunately it has a very green, and earthy flavor not acceptable in the majority of food products. Milling of this cake and dry sifting can increase the protein content to about 50%. Many researchers who recognized the nutritional value of this protein rich source, have used it as the starting material to isolate and improve the taste and functional qualities of the hemp protein. Tang found that hemp protein isolate (HPI) from the seed cake was inferior to SPI for use in making plant based foods (Tang et al., 2006). Tang showed that, for HPI, the poor water solubility of hemp globulin “is believed to result in its poor emulsifying and water holding properties when compared with soy protein isolate (Tang et al., 2006).” (Malomo & Aluko, 2015). According to Tang, “[t]he data suggest that HPI can be used as a valuable source of nutrition for infants and children but has poor functional properties when compared with SPI. The poor functional properties of HPI have been largely attributed to the formation of covalent disulfide bonds between individual proteins and subsequent aggregation at neutral or acidic pH, due to its high free sulfhydryl content from sulfur-containing amino acids.” (Tang et al., 2006). Further, “Differential scanning calorimetry (DSC) analysis showed that HPI had only one endothermic peak with denaturation temperature (T(d)) of about 95.0 degrees C., attributed to the edestin component.” (Tang et al., 2006).

Despite the apparent inferior functional aspects of hemp protein, its superior nutritional qualities have generated continued interest in its use in food production. To this end, individual proteins have been isolated from hemp and further studied for potential functional properties. Additionally, researchers have investigated whether different methods of extraction and isolation of hemp protein could improve functionality. “The value and application of hemp protein in food products are closely related to the protein structure and functional properties.” (Wang et al., 2019).

To investigate the nutritional and functional properties of individual hemp grain proteins, researchers have employed methods to extract and separate two of the primary proteins present in hemp grain. Hemp grain protein is primarily comprised of the proteins edestin and albumin. Edestin, a globulin, accounts for approximately 60% to 80% of the total protein content (Odani & Odani 1998; Tang et al., 2006), while albumin, a globular protein, but not a globulin, makes up the difference. Edestin and albumin have different amino acid composition and functional characteristics.

Malamo studied the nutritional differences between edestin and albumin in hemp grain and concluded that the edestin fraction of hemp protein is nutritionally superior, with higher sulfur-containing (methionine and cysteine), aromatic (AAA), branched-chain, and hydrophobic amino acids (Malomo and Aluko 2015). Malamo separated edestin from albumin and measured characteristics of each for nutritional value and functionality. These characteristic include solubility in water, amino acid content and digestibility.

Malomo reported that the albumin fraction is soluble in water, whereas the edestin fraction is soluble in salt solution. Extracted edestin has extremely low solubility in water at neutral or acidic pH and is soluble only at high ionic strength or alkaline pH (Malomo & Aluko, 2015). “Many protein functionalities such as surface-active properties are correlated with protein solubility.” (Jackman & Yada, 1989; Malomo & Aluko, 2015). In hemp grain, edestin was found to have better emulsion forming ability, while the solubility and foaming capacity of albumin are higher than those of edestin (Malomo & Aluko, 2015).

Research indicates that edestin may be found only in hemp grain, although edestin-like proteins, may exist in grains from a family that includes pumpkin and squash (Vickery, 1940). Therefore, the present disclosure and its applications may relate to edestin and edestin like proteins, which may have similar or identical properties to edestin. Vickery disclosed that potential substitutes for edestin might found in plants of the family Cucurbitaceae, which includes squash seed. Hirohata has examined the globulins of 38 varieties and species of eight genera of this family and has drawn attention to the close similarity of the globulins from closely allied species (Vickery, 1940; Hirotata, 1932). Vickery suggested that the globulin of the Cucurbitacea family may include edestin-like proteins that fulfill the requirements of a nutritional substitute for hemp-grain edestin (Vickery 1940).

Edestin was first isolated and analyzed by Thomas Osborne (Osborne, 1892). In its full native form, edestin is composed of six identical subunits, each consisting of an acidic (AS) and a basic (BS) subunit linked by one disulfide bond (Farinon 2020; Patel, Cudney, & McPherson 1994). Recently, it has been shown that edestin can exist in several forms, even within a single variety of hemp (Docimo et al., 2014). For example, in one variety of Cannabis Sativa, seven genes code for edestin globulins, and they result in divergent forms of two edestin types. Within certain strains of hemp, edestin of one type are practically identical to each other, whereas edestin of the second type are substantially different from the first. Ponzoni identified a type 3 edestin gene, CsEde3, which shows approximatively 65% and 58% sequence homology when compared to the genomic forms of CsEde1 and CsEde2, respectively (Ponzoni, Brambilla, and Galasso, 2018). Amino acid composition may vary significantly between the two types of edestin, with some types having greater nutritional quality (Docimo et al., 2014).
Edestin itself has a large particle weight of 309,000, but on denaturation depolymerizes to 51,000 in concentrated urea solutions [Burk & Greenberg, 1930] and to 17,000 in dilute HCl [Adair & Adair, 1934]. These units are respectively about ⅙ and 1/18 the size of the native molecule. In the native state they possess a specific polypeptide pattern, and are integrated partly perhaps by some form of chemical linkage (e.g. S—S bonds), but chiefly by lateral attractions between neighbouring CO and NH groups and by interactions between free acid and basic groups of the side chains. The number of these latter groups is high, as can be seen from the following analytical data: glutamic acid, 19-2%; aspartic acid, 10-2% [Jones & Moeller, 1928]; arginine, 17-76% [Vickery, 1940]; lysine, 2-4%, histidine, 2-03% [Tristram, 1939]; amide-N, 1-73% [Bailey, 1937, 2]. Allowing for amidized COOH groups, they correspond to a total of 670 charged groups per molecule of 309,000. The spatial arrangement of such charges gives rise to a specific charge symmetry on which the stability of the molecule must ultimately depend, and this is capable of some variation, as reflected in a change of dipole moment, within definite limits of pH. Outside these limits, a further suppression in the ionization of acid or basic groups sets up within the molecule attractions and repulsions which, especially in the absence of small mobile ions, distort and finally destroy the unique polypeptide configuration. (Bailey, 1940).

Therefore, edestin, as referred to in the present disclosure may incorporate all forms of edestin, as may be currently known or currently unknown, that have similar or identical properties to the edestin disclosed for the purposes of the present disclosure.

Edestin is subject to rapid degradation to edestan under mildly acidic conditions. Edestan, an intermediate product derived from edestin, occurs during the denaturation of edestin and was first identified by Osborne (Osborne, 1901; 1902). Edestan is formed when edestin comes into contact with dilute acids. Edestan results in the liberation of SH groups (Bailey, 1942). Bailey demonstrated that under acidic conditions edestin can be rapidly converted to edestan in less than 20 minutes (Bailey, 1942). This study showed that liberation of SH groups is concomitant with the conversion of edestin to edestan. Bailey also reports a decrease in nitrogen content for edestan when compared to edestin, which could be explained by a reduction in tryptophan in edestin. Edestin in its non-denatured, native state has different functional properties than denatured or partially denatured edestin or edestan.

Conventional techniques for isolating hemp protein, or separating edestin from albumin, may cause structural changes in the protein, some of which may be irreversible. Different protein extraction and isolation techniques and conditions (pH, presence or absence of mono- and polyvalent salts, ionic strength of medium used for protein extraction, time, temperature, etc.) can influence protein functional properties (Hadnadev et al., 2018). These changes can negatively affect the functionality of the protein (Hadnadev et al, 2018; Shen et al., 2021). These negative effects may include changes to digestibility, protein-oil interactions, taste, solubility, and emulsifying and gel formation capability (Shen et al., 2021). Therefore, when extracting and isolating edestin, particularly for use in food products, it is critical to maintain the native structure of the protein to the greatest extent possible.

A number of different techniques have been utilized to isolate hemp proteins and edestin. These techniques include the use in aqueous or solvent slurries, of high temperatures, alkaline or acidic conditions, isoelectric focusing, micellization, ultrafiltration, and mechanical processes, including pressing, milling or sifting the grain or hulled grain, or milling the grain and sifting a grain slurry. Any one of these techniques has the potential to alter protein structure and decrease its functionality.

High temperatures created by mechanical processes can negatively affect protein functionality. For example, milling grain to produce flour may generate temperatures high enough to alter the structure of proteins. These temperatures may cause denaturing of the edestin and binding or aggregation between edestin, albumin or fiber potentially, thereby interfering with their independent isolation.

Dry milling of grain may generate temperatures of at least 80° C. to 100° C., potentially denaturing edestin. Mohammad found that heat and mechanical forces generated during milling can denature globular proteins (Mohommad, 2015). Mohommad showed that mechanical stresses applied during the milling can change the bulk properties of globular proteins.

The high temperatures caused by dry milling to produce flour may, therefore, alter hemp protein structure. Farinon calculated the denaturation temperature of hemp grain protein (edestin) to be 92° C. (Farinon et al., 2020). Further, Malamo showed that heat treatment, as well as changes in pH, may alter the secondary structure of hemp grain albumin and edestin (Malomo and Aluko, 2015). High temperatures may cause proteins to unfold, thereby exposing their hydrophobic groups and favoring protein-protein interactions over protein-water interactions.

Heating during extraction may be avoided or minimized by using chemical means of protein extraction, however, many chemical methods of extraction first require mechanical reduction in grain size. Solvent extraction is a common method of separating proteins from plant material involving the use of a liquid solvent into which the protein containing material is added. The solvent may be water, alcohol, acetone, hexane or other liquid solvent. Solvent extraction may be combined with mechanical or other means of extraction that first break down the plant material allowing proteins to be released. Solvent extraction may involve the use of solvents that break down plant cell walls or fibrous material, thereby releasing proteins.

Some solvents used in protein extraction have the disadvantage of denaturing proteins. Further, these solvents may be toxic and not suitable for ingestion, even in small quantities. Additionally, solvents generally require long extraction time, labor-intensive procedures, leave residual solvent in a food product and may be difficult to dispose of safely. Hexane is an example of this type of solvent. Many solvents cannot be used to produce certified organic food products under United States Department of Agriculture's (USDA) guidelines for organic food labeling.

One alternative process of protein extraction that does not require solvents is aqueous extraction, which involves adding plant material, which has been milled or pressed, to water, followed by separation of proteins based on solubility of proteins in the aqueous fraction or the solubility of proteins in the fat containing fraction when fats in the plant material separate from the water. Aqueous extraction may be followed by isoelectric focusing or salt extraction to isolate a protein.

Alkaline extraction is a common technique where a highly basic solvent breaks cell structures, thereby releasing proteins from the cell. This process, however, can result in damage to the protein, including amino acid racemization, lysinoalanine formation, digestibility decrease and loss of essential amino acids (Moure et al., 2006). According to Xu, under alkaline conditions, polyphenols, found in many plant materials including hemp grain, oxidize and subsequently can react with protein, resulting in dark green or brown color of extracted protein solutions (Xu and Diosady, 2002).

When used during hemp grain protein extraction, alkaline extraction pH is generally raised to 9 or 10, higher than that for legume protein extraction (pH 8), because native hemp grain proteins are tightly compacted, and may be closely integrated with other components, for example, phenolic compounds (Wang and Xiong, 2019). Alkaline extraction is generally followed by precipitation of a target hemp protein at an isoelectric point, and after several washing steps, often, the induced color cannot be removed from protein isolates.

Aqueous or alkaline extraction is generally followed by isoelectric focusing or salt extraction to isolate a protein. Isoelectric focusing may be used after alkaline or solvent extraction to extract a soluble protein and involves adjusting the pH until an equilibrium of charge between the target protein and the solvent is reached, thereby causing the protein to precipitate from solution. Isoelectric focusing requires changes in pH that may alter protein structure, thereby negatively affecting protein functionality.

With regard to isoelectric focusing for edestin, Bailey discloses that the isoelectric zone of edestin is pH 5.5 (Bailey, 1942). In this process, albumins can largely be eliminated during precipitation of edestin at its isoelectric point (Papalamprou et al., 2009). This result may be ascribed to high solubility of hemp grain albumins (>75%) at pH 5.0, in comparison to hemp grain globulins (<10%) (Malomo & Aluko, 2015). One advantage of isoelectric focusing over other protein isolation methods is that water binding capacity has been found to be higher for protein isolates obtained by isoelectric focusing in comparison to the same isolates derived by micellization extraction (Krause et al., 2002). A disadvantage of isoelectric focusing during edestin isolation, however, is that solubility of the protein is lower when compared to edestin isolated by salt extraction, suggesting that the protein is no longer in its native state (Hadnadev, 2018).

When compared to alkaline extraction and isoelectric focusing, salt extraction, which may involve micellization, represents a milder extraction procedure, one that does not cause polyphenol oxidation, polymerization and co-extraction with protein. Salt extraction involves “salting in” a group of proteins followed “salting out” of a target protein. “Salting in” refers to an effect where increasing the ionic strength of a solution increases the solubility of a solute, such as a protein. This effect tends to be observed at lower ionic strengths. “Salting out” involves increasing the salt concentration further, such that the abundance of the salt ions decreases the solvating power of salt ions, resulting in the decrease in the solubility of a target protein and precipitation.

One method of salt extraction, as described in U.S. Pat. No. 6,005,076 to Murray, includes a micellization step. Salt extraction using micellization involves first solubilizing proteins with a salt solution having a certain ionic strength. Next, the saline solvent is diluted in the concentrated protein solution to reduce the ionic strength below a certain level, thereby causing the formation of discrete protein particles in the aqueous phase at least partially in the form of protein micelles. The protein micelles then settle to form a mass of target protein isolate. The protein isolate may then be separated from supernatant liquid.

Salt based micellization extraction, such as that disclosed by Murray, has the advantage of producing protein isolates of higher solubility in comparison to isolates obtained by isoelectric focusing (Karaca et al., 2011; Krause et al., 2002; Paredes-Lopez and Ordorica-Falomir 1986). In addition to improved solubility, interfacial activity was higher for protein isolates obtained by the micellization technique when compared to isoelectric focusing. Further, according to Krause and Papalamprou, micellization extraction resulted in protein isolates of more preserved native protein structure when compared to isoelectric precipitated proteins (Krause et al., 2002; Papalamprou et al. 2009). Generally, isoelectric focusing results in some degree of denaturation of extracted proteins, and this can result in hydrophobic interactions between protein molecules, leading to the formation of insoluble protein aggregates. While salt extraction and micellization may be the least damaging of the known methods of hemp protein isolation, the addition of salt during isolation does have a negative impact on protein structure and function. “The addition of NaCl also exerts different influence on the gel structures. Specifically, increasing NaCl concentration (up to 300 mM) promotes intensive protein—protein interactions and aggregation, causing the formation of HMI [Hemp Protein Micellization Isolates] gel structure with larger pore sizes.” (Shen et al., 2021).

Salt extraction was the first method used to isolate edestin from hemp grain (Osborne 1892). This method was further developed by Malomo, who utilized the micellization technique to extract edestin (Malomo and Aluko, 2015). As Malomo demonstrates, during salt based micellization extraction, albumins remain in the supernatant after salt removal in the dialysis step, while globulins precipitate and can be collected by centrifugation. In Malomo, a globulin isolate was produced through salt extraction of hemp grain meal followed by dialysis in dialysis tubing against water.

Dialysis of a salt extract of hemp grain meal led to precipitation of the water-insoluble globulin in micelle form while albumin remained in solution (Malomo and Aluko, 2015). The precipitate was then collected and freeze-dried. When comparing hemp protein albumin and globulin fractions, albumin had significantly higher protein solubility and foaming capacity than globulin, while no differences in emulsion forming ability were observed between the two protein fractions. Salt extraction, and micellization, has high labor, time, material, equipment and waste disposal costs, and is not currently considered to be commercially viable for protein extraction for use in food products.

Ultrafiltration is another method that may be used to generate protein isolates having improved functional properties when compared to other conventional protein extraction techniques. For example, when compared to alkaline extraction, protein isolates obtained by ultrafiltration generally have better emulsifying properties. One disadvantage of ultrafiltration, however, is membrane clogging due to the precipitates forming in the final product, which can result in high extraction costs.

Newer methods of protein extraction include ultrasound assisted extraction, enzymatic assisted protein extraction, and electrical methods of protein extraction. These methods have disadvantages including high cost, low yield, protein degradation and protein impurity. Conventional methods of extraction, including salt extraction, alkaline extraction and isoelectric focusing therefore still predominate as methods of extracting proteins from plant material such as hemp grain.

With regard to published methods of extracting and isolating hemp using the methods described herein above, an example of aqueous protein extraction of hemp grain followed by isoelectric focusing is disclosed in U.S. Pat. No. 10,555,542 to Crank. Crank discloses first milling of the hemp grain using any suitable means including grinding using a hammer mill, roller mill or a screw-type mill. Milling by these processes is a high energy process that generally results in high temperatures, generally around 140° F. to 150° F. To achieve a paste, these high temperatures are required, as paste formation from solid does require a certain high temperature, as is known in the art of peanut butter production. These temperatures may cause undesirable interaction between protein components of the grain material, in some cases, depending on the final application of the product. In Crank, milling produces a paste or a flour (a flour when the grain is first pressed to remove oil), where water may be added to the milled material in a ratio of about 4 to about 16 parts by weight to each part of plant material. Crank discloses adjusting the pH to approximately 7.5 by adding a base, such as calcium hydroxide, to facilitate extraction of the proteins.

The resulting solution is then centrifuged to separate the fat fraction from the aqueous fraction, or reduced-fat extract. The reduced-fat extract can be used as reduced-fat plant milk or be further processed to produce protein concentrate or protein isolate. In Crank, proteins in the reduced-fat extract were concentrated by precipitation and separated to produce a plant protein concentrate or isolate from partially defatted plant material. Crank discloses the proteins in the reduced-fat extract can be precipitated by adding acid, such as citric acid, to the isoelectric point of the protein. Crank does not disclose that aqueous extraction alone may be used to separate edestin and albumin. Further, while Crank does mention in the application that hemp seed may be a source of protein isolated for food products according to the Crank process and that the hemp seed contains edestin, Crank does not disclose the purification and isolation of edestin. Crank discloses discarding the fiber and protein containing portion of hemp protein after centrifugation.

Czechoslovakia Pat. No. 33,545 to Beran discloses a method for extracting edestin from hemp grain to produce a protein for human consumption. In the background section of the patent, Beran discloses that hemp protein is often produced as a spray dried hemp protein isolate, which often utilizes high heat, and may cause protein denaturation. According to Beran, spray drying may require temperatures between 150° C. and 250° C.; temperatures that are likely to denature hemp proteins. Beran discloses that “[t]hermal denaturation of proteins adversely affects the solubility and dispersibility, foaming and emulsifying properties.”

In order to avoid thermal denaturation during preparation of edestin caused by spray drying, Beran discloses a method that includes first grinding or pressing hemp grain to remove the oil, followed by aqueous extraction and either isoelectric focusing or salt extraction to purify edestin. The preferred method of grain size reduction used in Beran appears to be dry milling. According to the patent, the milled flour is then added to water in a concentration of 5:1 water to flour ratio. Beran then discloses shaking the solution to produce an albumin containing water fraction and a sediment fraction.

Beran does disclose that the sediment contains edestin, however, Beran discloses further steps to isolate edestin for use in food products. These steps include protein extraction by either isoelectric focusing, salt extraction or ultrafiltration. Beran does not discloses a level of purity of the edestin in the sediment prior to the additional steps to isolate edestin, however, the need for such additional steps indicates that the purity of the edestin in the sediment is not sufficient for the stated purpose of the Beran patent, which is to use edestin to “increase the protein content of high protein foods and smoothies protein beverages.” In conclusion Beran discloses that “[t]his product can be used in these foods due to its emulsifying properties and beneficial effect on the organoleptic properties of the final product.”

Both Crank and Beran generally disclose the use of milled or pressed hemp grain, (to remove the oil), and subsequently ground to hemp flour as a starting material for protein extraction. Consequently, the hemp flour has been subject to dry milling or grinding, and oil pressing processes that affect the structure and functionality of the protein. Further, both Crank and Beran disclose isolation of edestin by at least isoelectric focusing, which results in structural changes to the protein, thereby decreasing its functionality.

During the process of extracting protein from grain for use in a plant based meat, oil may also be extracted from the grain. Extraction of oil may, in some cases, be a primary objective, as plant based oils have value as food and cosmetic products. Common methods of extracting oils from grains, nuts and seeds include press-based methods of extraction, including cold pressing and expeller pressing, as well as solvent extraction.

Pressing grain to extract oil involves mechanical compaction of the plant material to force oil from the solids. Solvent extraction involves placing plant material into a liquid to extract the oil. Pressing and solvent extraction may, in some cases, be combined. Oil recovery from an extruder press method may be relatively inefficient and a fairly high percentage of fat may remain in the cake. Consequently, the pressed cake may be further extracted using an oil solubilizing solvent. Commercially available cakes and flour produced by press methods or press and solvent methods, are thought to have reduced protein functionality.

Conventionally produced hemp grain oil may have a green color that can result from the rupturing of protoplastids or chloroplasts during extraction. Hemp grain may contain chlorophyll containing bodies that release chlorophyll when ruptured. Hemp grain, when compared to other types of grains, contains a greater number of these bodies, and therefore tends to have a green color when hemp oil is extracted by conventional methods.

According to Leonard et al. “Unrefined hempseed oil is dark green in color, which is due to its chlorophyll content.” (Leonard, 2019). Further, the presence of chlorophyll in oil can cause oxidation of fats, leading to off-flavors. U.S. Pat. No. 9,493,749 to Soe discloses “vegetable oils derived from oilseeds such as soybean, palm or rape seed (canola), cotton seed and peanut oil typically contain some chlorophyll. However, the presence of high levels of chlorophyll pigments in vegetable oils is generally undesirable. This is because chlorophyll imparts an undesirable green colour and can induce oxidation of oil during storage, leading to a deterioration of the oil.”

Various methods have been employed in order to remove chlorophyll from vegetable oils. These methods including chemical bleaching and ultrasonic bleaching. Chlorophyll may be removed during many stages of the oil production process, including the grain crushing, oil extraction, degumming, caustic treatment and bleaching steps. The bleaching step, however, is usually the most significant for reducing chlorophyll residues to an acceptable level. During bleaching, the oil is typically heated and passed through an adsorbent to remove chlorophyll and other color-bearing compounds that impact the appearance and/or stability of the finished oil. The adsorbent used in the bleaching step is typically clay.

Conventional methods for removing chlorophyll from hemp oil are costly and may create problems for waste disposal. Further, methods that remove chlorophyll from hemp oil after the chloroplast has been ruptured allow for oxidation of the oil due to temporary exposure to chlorophyll. Therefore, improved methods for extracting oil from hemp grain are needed.

In the production of meat and dairy analogs, after obtaining the protein isolate and a preferred source of oil, step two involves combining the isolated protein with water and possibly oil to form a material for setting or extrusion. After protein has been isolated from hemp grain or other plant products, it must be combined with other components of a meat or dairy analog in order to form a final meat analog product. Three basic ingredients for meat analog production are protein, water and fat. These components may be combined in different concentrations and processed in different ways in order to form meat and dairy analogs.

Given that meat analogs require gelation, or structuring resulting in a chewy meat-like texture, the protein is typically combined with water and possibly oil to form a gel that can be set by heat creating a texture. With regard to hemp protein isolate gel formation using these components, or protein and water only, research has shown that hemp protein does not have good gel forming properties. As disclosed above, Wang, Shen, and Zahari teach that hemp does not have good gel forming capability, which would make it an unlikely candidate for its use as a primary protein in a meat or dairy analog (Wang et al., 2019; Shen et al., 2021; Zahari et al., 2020). Wang, for example showed that the combination of hemp protein isolate and water, alone, when heated, did not form a desirable gel. Wang also showed that even when oil was added to the protein and water mixture in Wang and heated, again, the hemp protein, water and oil mixture did not form a desirable gel upon heating.

In meat analog production, the third step of thermal setting of the protein, water and oil typically includes extrusion, which texturizes the product to form a more meat-like material. In order to form a texturized meat, an extruder may be used to form a Textured Vegetable Protein (TVP). TVP is typically a soy-based product, however, other plant proteins, such as pea, may be used alone or in combination with soy. To generate TVP, plant based ingredients are fed into an extruder to be texturized. Conventionally, dry plant protein is fed into the extruder, whereupon water, starch, and occasionally fat are added to the protein through separate inputs as the protein is conveyed through the extruder. After extrusion, the extruder output may go through marination, coating, and/or cooling steps.

Common problems with conventional plant based meat substitute products, including TVP and HMMA, relate to a non-dispersing texture and rubbery mouthfeel when compared to meat. This texture and mouthfeel of conventional meat analogs results in part from the lack of incorporation of either fat, oil or combination thereof into the molecular structure of the protein peptide strands or “fiber”. Meat sourced from animals has fat molecules incorporated between these muscle fibers, which comprise the majority of an animal meat product. This fat is released during chewing, providing a consumer with positive and continuous sensory feedback in terms of taste and mouthfeel as mastication is continued. The sensory feedback provided during the chewing of current conventional meat analogs is not equivalent to that of meat, in part because there is no fat between the peptide layers of the protein. In conventional meat analogs, fat is added after the protein has been fully denatured and hence, may surround the significant sized pieces of cooked protein, but is not incorporated within the peptide layers of the protein itself.

Soy and pea proteins, which are commonly used to create fibers in TVP and HMMA, may only hold approximately 10% of their weight in fat. Typically, a muscle fiber in meat incorporates anywhere from 5 to approximately 50% of its weight as fat within the protein fibers, depending on the source of meat. Therefore, with conventional soy and pea meat analogs, much of the fat added to the product during extrusion rests outside of the fibers, creating a greasy, unappealing product that doesn't release fat in a controlled and succulent manner as it is chewed. As a result, conventional meat analog products mainly appeal to a limited number of committed vegan or vegetarian consumers, and have failed to appeal to the majority of consumers who eat meat.

Different extrusion methods may produce different meat analog textures. Extrusion has been developed over decades to create more meat-like meat analogs. Extrusion, and preparation for extrusion, of a meat analog involves complex chemical changes and processes within the protein component of the extrusion mixture. During extrusion, protein isolate structure is significantly altered, whereby the protein may be partially or wholly denatured or unfolded, as well as repositioned and cross-linked with other protein molecules and chemically bound to the other components of the extrusion mixture. The extruder induces these changes through the application of shear forces applied by screws as the mixture moves through the machine, in addition to changes in temperature and pressure. The final texture, taste and mouthfeel of a meat analog produced by extrusion is determined by the various types of chemical bonds that form between the components of the extrusion mixture prior to, during, and after extrusion.

With regard to the early development of extrusion processes for producing textured meat analogs, U.S. Pat. No. 6,319,539 to Shemer et al., assigned to Tivall LTD., disclosed mixing proteins with a large proportion of water and potentially fats, and subjecting the resulting paste to heating, gelling and shaping in an extruding machine. During transfer into the extruding device, Shemer discloses the paste being heated and conveyed at a determined rate and then extruded through an opening. The resulting food product has a fibrous texture comprising substantially aligned axial fibers. The problem with this process, however, is that it has a limited flow rate and can only be implemented using certain raw materials, in particular gluten, which resulted in a limited variety of products. Gluten is a known allergen which also has limited to date the uses of soy based TVP.

An additional drawback of the Shemer process, and other early extruder processes, is that the heated product would expand as it was conveyed from the extruder due to water vapor release as the high temperature product cooled. The water vapor caused disordering of the aligned protein fibers, which is undesirable for acceptable texture in a meat analog.

To solve this problem, Clextral S.A.S. developed technology disclosed in WO 2003/007729 to Bouvier et al., a patent application describing a twin screw rotor extruding machine, as opposed to a single screw device, having an elongate cooling chamber, allowing for the raw material to be mixed and extruded at a controlled temperature, such that steam would not disrupt the alignment of the protein fibers in the final product. In addition to addressing the cooling and water vapor problem, the '729 application also recognized a problem in the existing art with incorporating the desired amount of oil and fat into an extruded product using conventional formulations of raw material.

To achieve the desired fat content, the '729 application disclosed a novel extrusion mixture containing fatty ingredients mixed with lecithins or caseinates, protein, fibers, starches and water. This mixture was kneaded to obtain a paste which would be subjected to heating and gelation in the extruder. Inclusion of significant quantities of carbohydrates such as starch in a meat analog, however, is undesirable due to taste and nutritional concerns.

To solve the problem of introducing fat into a meat analog without the addition of starch and without other associated problems with introducing oil into an extruder, Ojah B. V. developed technology disclosed in WO 2012/158023 to Giezen et al., which describes an extrusion process for turning vegetable protein compositions such as soy protein into a fibrous, meat-like structure. Giezen discloses an extrusion exit temperature above the boiling point of water, resulting in an open product structure capable of being infused with an oil to reach a desirable fat content. Problems with Giezen include the addition of a process step after extrusion and a final product perceived as too greasy and fatty by the consumer.

A problem commonly recognized in the art of meat analog extrusion is that higher amounts of oil in the extrusion mixture interfere with obtaining a product having the texture of animal meat. In conventional meat analog extrusion, the presence of oil reduces the high mechanical shear forces within the extruder that form the fiber structure of an ideal meat analog. Therefore, using conventional processes, addition of optimal amounts of oil results in a meat analog with suboptimal fiber structure and texture.

To overcome problem of higher oil content causing suboptimal texture in textured meat analogs, Nestec developed a process, disclosed in U.S. Pat. App. No. 20180064137 to Trottet et al., for adding oil separately from the other raw materials during extrusion. This process includes feeding an extruder barrel with 40-70 wt % water and 15-35 wt % plant protein, followed by injection of 2-15 wt % oil into the extruder barrel at a point downstream of the feeder. According to the disclosure, the downstream location of injecting the liquid oil is preferably within the second half of the total length of the extruder barrel. Ostensibly, this configuration allows for high shear forces in the first half of the extruder to promote fiber formation, while the oil can be added downstream without interfering in fiber formation.

While Trottet's process results in an improved product when compared to the prior art, Trottet does not result in a significant amount of oil being incorporated into the core of the protein fiber. Without the oil being incorporated into the fiber, the resulting product is perceived as greasy by a consumer, and lacks a controlled release of fats during chewing. This unsatisfactory result is because people are accustomed to eating animal meat, in which a large amount of fat is incorporated into the muscle fiber. Animal meat protein fibers incorporate up to approximately 50% of their weight in fat, although this varies depending on the source of the meat. With the Trottet process, fat is only incorporated into the fiber in an amount of about 10% of the weight of the plant protein fiber. This problem with Trottet's process is caused by both the type of proteins used as raw material for extrusion, which for Trottet are disclosed as soy and wheat, and the method by which oil is added to the protein fiber.

In another patent application addressing the fat content of meat analogs, Nestle filed Pat. App. WO 2020/208104 to Pibarot in 2020. In a filing entitled “Meat analogs and meat analog extrusion devices and methods”, Pibarot acknowledges the problem of mimicking the fat content of animal meat, which has inclusions of fat tissue within and without the protein matrix. Pibarot suggests that this complex architecture may drive the appearance of the meat as well as texture and juiciness of the meat.

To solve this problem, Pibarot discloses injecting fat into the interior of an extrusion mixture as it is being cooled in the die. In Pibarot, gaps are generated between protein fibers of the extrusion mixture during extrusion. As the heated and sheared product is conveyed through the cooling die, fat is injected between these gaps, such that fat is deposited between the protein fibers. Pibarot submits that this process produces a marbled appearance, similar to that of red meat, and improves the texture and palatability of the product. Pibarot discloses using this process with soy, pea and other conventional plant protein sources. Pibarot does not, however, teach a method of incorporating the fat into the molecular structure of the protein fiber.

To summarize, the Shemer process could only be used with a limited number of ingredients and the lack of controlled temperature and cooling resulted in an inferior product. While Bouvier solved the cooling problem of Shemer, to achieve the desired fat content, Bouvier blended the raw extrusion material with high amounts of starch, resulting in undesirable taste and nutritional qualities. Giezen solved the starch problem of the Bouvier process by adding fat after extrusion, however, this required an additional step and resulted in a greasy, unpalatable product. Trottet improved upon both Giezen and Bouvier by introducing oil at a late stage of extrusion, however, Trottet still suffers from the problem of low incorporation of oil into the protein fibers of the meat analog. Pibarot discloses injection of fat into the meat analog as it is cooled, which introduces fat between protein fibers, but does not produce a final product that incorporates fat into the protein fibers.

Hemp grain has great value both as a source of protein and as a source of oil. While a wide variety of methods for producing food products from hemp grain exist, it is clear that more effective, efficient, cleaner and less costly methods of extracting proteins and oil from hemp grain are needed to produce a clean and bland tasting, un-oxidized hemp protein having significant purity, gelling functionality, nutritional value, digestibility and flavor, as well as an oxidatively stable oil having a clean flavor and light color suitable for cooking and cosmetics. Further, there is a continued need for a processes and raw materials that can be used to create a variety of meat analogues having the appearance, taste, texture, juiciness and mastication of a variety of animal meat and dairy products. More specifically, there is a need for a meat analog that has the appearance, texture and taste of meat with an optimal amount of oil or saturated fat in the final product, where the oil or saturated fat is incorporated into the protein fibers at a level approximating that of an animal meat or dairy source.

### SUMMARY

The present disclosure solves the problems of the prior art with regard to hemp protein isolation, raw material input preparation, and processing of the raw material input, in order to produce a superior plant based meat and dairy analog. The composition and process of the present disclosure includes a process for hemp grain protein isolation, pasteurization, liquid solution, gel formation, texturization and meat and dairy analog production. The process of the present disclosure results in a structure protein food product, or meat analog, having superior properties when compared to existing products or similar products manufactured using known technology.

Preparation of a meat or dairy analog according to the process of the present disclosure may be divided into three broad steps. The first step involves protein extraction, or isolation, from a hemp grain. The second step involves combining the isolated protein with water and oil to form a raw material for thermal gelation or extrusion. The third step involves thermal gelation or extrusion of the raw material to set or texturize the meat analog. The final meat analog product may then be cooked to simulate meat or dairy products such as chicken, fish and cheese.

With regard to the first step, hemp protein isolation, the process of the present disclosure incorporates a known grain processing method, disclosed in U.S. Pat. No. 7,678,403 to Mitchell (“Mitchell” or the “'403 patent”), with some modifications. The '403 patent is herein incorporated in its entirety. The Mitchell process discloses aqueous wet milling at low temperature and sifting the resulting product. In the present disclosure, aqueous wet milling may preferably be done while maintaining the temperature of the slurry between, preferably 33° F. and 38° F. At higher temperatures, particularly at 42° F. and higher, microorganism growth becomes a concern.

In some embodiments, milling may be performed with whole hemp grain or hulled hemp grain (also referred to as dehulled hemp grain). Depending on whether whole or hulled hemp grain is used, the final meat or dairy analog product may have a different color. The use of whole hemp grain results in a darker, more beef-like color, while the use of hulled hemp grain produces a more white, chicken or fish-like color. Use of part whole hemp grain and part hulled hemp grain, in one embodiment, wherein the whole hemp grain is used in a concentration of about 20-30% by weight, relative to the amount of hulled hemp grain, results in a beef-like color to the final product. In one embodiment, hulls that have been previously removed by dehulling of hemp grain, may be reintroduced to the hulled hemp grain to add color; where, in one embodiment, to achieve a beef-like color, the hulls may be added to the hulled hemp grain in an amount of approximately 10-15% by weight relative to the hulled hemp grain.

After aqueous wet milling, Mitchell, in the '403 patent, teaches sifting at a different mesh size than the present disclosure, where in the present disclosure sifting at a 170 to 200 mesh size is preferred. Mitchell, in the '403 patent, when discussing the sifting of rice grain for milk production, disclosed mesh size of 150 or below, which is appropriate for certain grains, but not for chloroplast removal for hemp grain. The present disclosure has surprisingly discovered that a 170 to 200 mesh size, preferably, or between approximately 160 and 200 mesh, prevents passage of chloroplasts or chlorophyll containing particles through the filter, while not significantly decreasing protein or nutrient yield, such that sufficient protein particles may pass through the filter.

When hemp grain is processed according to the modified Mitchell process it results in an insoluble protein-containing precipitated byproduct. This protein-containing material was discovered by Mitchell to have unique and valuable properties and is particularly well-suited for producing meat and dairy analogs. This hemp grain protein-containing material has not been publicly disclosed. Upon further investigation, Mitchell determined that the material was comprised primarily of edestin and is, importantly, substantially free of albumin, the other primary protein component of hemp grain. Due to processing parameters of the Mitchell process, the edestin appears to be substantially maintained in its native state. Due to its high concentration of substantially native edestin, the material will be referred to hereafter as native edestin protein isolate (NEPI). Comprised of approximately 80% protein, NEPI also contains oil, fiber, carbohydrates and ash.

After milling and sifting, NEPI may be separated from an aqueous oil albumin emulsion (AOAE) by centrifugation and decanting. The aqueous oil albumin emulsion may optionally be further processed to produce hemp oil and albumin. NEPI extracted according to the present disclosure may be used in a variety of different plant based food product that replicate meat or dairy products. NEPI may optionally be combined with an oil to form a protein hydrosol and a protein-fat hydrosol, and may be processed to produce an evaporated or spray dried product. The hydrosol may be used to produce a plant based meat analog.

This disclosure is based on methods and materials for making plant based products that more closely replicate meat products, including the texture, juiciness, fibrousness and homogeneity in texture of animal meat. A process for producing meat analogs is described herein that includes selection of proteins based on their unfolding, or denaturation, properties and fat holding capacities. Further, the process described herein includes a method of preparing an extrusion mixture or input, which may be a protein-fat hydrosol, prior to extrusion, that incorporates water and fat into the selected protein in a manner such that the water and fat form a liquid matrix, which also may be referred to as a protein-fat hydrogel, with the protein. In some embodiments, the liquid matrix may have additional components, whereas the protein-fat hydrogel may not have more than protein-fat and water. Still further, the process described herein includes methods of extruding or otherwise heating of a liquid matrix, which may also be referred to herein as an extrusion input or extrusion mixture, where the liquid matrix may be a fat-protein hydrosol. The process of extruding the liquid matrix includes feeding the liquid matrix into a pump at a first end of an extrusion chamber. The liquid matrix is fed into an extruder, wherein the extruder is set for parameters tailored to the liquid matrix.

The present disclosure relates to a composition containing edestin or edestin-like proteins and methods for isolating edestin from hemp grain. As disclosed herein, edestin may be isolated from hemp grain or other grains and seeds that contain edestin or edestin-like proteins. In one embodiment, the hemp grain is wet milled during aqueous protein extraction, resulting in an edestin containing fraction and an aqueous oil albumin emulsion.

The present disclosure may, in one aspect, utilize a method of aqueous wet milling to separate fat stored within the hemp grain without rupturing the chloroplasts and releasing chlorophyll into the oil. Once the seeds have been milled by this process, the resulting milled product is sifted through different size mesh. Sifting over between approximately 170 mesh, or in some embodiments between 160 and 200 mesh, or in some embodiments between 200-270 mesh removes hulls, chloroplasts and fiber. More preferably, a mesh size of between 160 and 200 may be used. In one preferred embodiment a mesh size of 170 may be used. A mesh size of 150 has openings that are too large and may allow undesirable material into the filtrate, including fibers and chlorophyll containing material. Surprisingly, chlorophyll containing particles remain at a size greater than the pore openings of 170 mesh, while most protein containing particles pass through mesh of this size. According to the process of the present invention, sifting with different size mesh separates the chloroplasts, protoplastids or other chlorophyll containing particles from the hemp oil and protein containing fraction, resulting in a pale, yellow final oil product.

In the process of the present disclosure, after sifting, an insoluble fraction containing NEPI and albumin oil aqueous emulsion may be present in the filtrate. The AOAE may be decanted after centrifugation. The insoluble fraction and pellet containing portion may be washed to remove any residual oil. In some embodiments, washing with cold water may be performed twice.

In some embodiments, the AOAE may be chilled at between approximately 33 F and 38 F, wherein 35 F is preferred, until the albumin begins to separate from the oil in the emulsion and precipitate, which in some embodiments may be aided by centrifugation. According to the process of the present disclosure, albumin strongly binds hemp grain oil, thereby improving separation of oil and albumin from the insoluble edestin fraction, or NEPI. The albumin may be separated from the hemp grain oil by this process. Gel electrophoresis shows that substantially all albumin may be removed from the NEPI by this process, leaving primarily edestin in the NEPI. The AOAE may be removed from the NEPI by centrifuging and decanting, leaving the NEPI as a solid material that may be washed to remove residual material.

NEPI may, in one embodiment, then be heated to a temperature of approximately 145° F. for 30 approximately 30 minutes to pasteurize the product. 145° F. may be a legal lower limit for pasteurization in some jurisdictions. Here, the temperature should be maintained at approximately 145° F., or between 145° F. to 155° F., in order to prevent granulation that has been observed in the present disclosure to occur at higher temperatures. Granulation may occur in NEPI at temperatures well below the denaturation of edestin, for example at approximately 158° F.; therefore, it is critical to pasteurize at temperatures that are below those typically used by those of ordinary skill in the art for pasteurization. Those of ordinary skill in the art conventionally pasteurize protein isolates at temperatures that would cause significant granulation in the present disclosure, in order to rapidly process the product. After pasteurization is complete, NEPI may be spray dried or stored as a concentrate for use in meat and dairy analogs. Spray drying should be done at lower temperatures, preferably around 145° F. to 155° F., as well, to prevent granulation or aggregation of the protein.

In some embodiments, particularly for commercial applications, the NEPI comes off the production line into a tank that is heated to 145° F., the product is allowed to incubate at this temperature for 30 minutes, prior to being sent to a cooling tank for cooling to approximately 35° F. After cooling, NEPI can be shipped if necessary for spray drying, freezing, freeze drying or vacuum microwave drying prior to use in production of meat and dairy analogs, or structured protein food products.

For meat analog production, the pasteurized product may be prepared by first hydrating the NEPI, if dried, or otherwise maintaining an appropriate degree of hydration. In one embodiment, the amount of water may be approximately 3 parts water to 1 part NEPI. Prior to addition to NEPI, the water may be preheated, preferably to approximately 135° F. to form a protein hydrosol prior to setting. Salt should not be added during this process, as it may disrupt protein hydrosol structure. Salt may be added just prior to the set or after the set, but not before. In some embodiments, protein hydration and opening may be performed at 100° F. to 135° F., or in some embodiments between 100° F. and 155° F.; or in other embodiments protein hydrosol formation may be performed at lower temperatures, however, the temperatures must be above cold temperatures which do not allow for protein opening. Preferably, temperatures during the hydration and protein-preparation step should remain as close as possible to 145° F., which is considered the lowest temperature for pasteurization, without reaching temperatures that produce granulation of the product.

Once the protein is hydrated, in one embodiment oil may be added and mixed with the protein hydrosol to form a protein-fat hydrosol. Oil should not be added until after the NEPI is sufficiently hydrated, such that the protein hydrosol is has a smooth appearance. If oil is added prior to hydration and protein-preparation, granule formation may occur. Further, according to the process of the present disclosure, oil should be added prior to setting of the material, setting meaning where protein bonds are formed to create a more solid gel product, where aggregation of the proteins occur, generally at higher temperatures where protein denaturation occurs. In the case of the present disclosure, there is an absence of free oil during the setting process, and all oil is incorporated into an emulsion, or protein structure, prior to setting of the product in the extruder or other means of heat setting. In conventional extrusion, there will be free oil present with material that is partially or completely set in the extruder. It is therefore important, for the present disclosure, to add water to fully hydrate and open up the NEPI prior to addition of oil in order to have an absence of free oil during extrusion or setting. This protein-fat hydrosol may then be heated or extruded to form a meat analog. In conventional extrusion, using soy or pea protein for example, the oil is added to the protein material after setting has begun at high temperatures in the extruder more for lubrication rather than incorporation of the oil.

Once the protein hydrosol is sufficiently hydrated, oil may be added to form the protein-fat hydrosol. Oil may be preferably preheated, wherein the temperature of the oil may preferably be between approximately 130° F. to 135° F. In other embodiments, the oil may be preheated to between 100° F. to 135° F., or between 100° F. and 155° F., while in other embodiments the oil may be added at lower temperatures, however, the oil should not be added at cold temperatures that would disrupt the structure of the protein hydrosol and prevent incorporation of the oil into the protein hydrosol to form the protein-fat hydrosol. The material may also be set in a retort system, although retort may not produce a fibrated product as a does extrusion.

Texture of the retorted NEPI meat analog was surprisingly good and had textural properties, including hardness and chewiness that are far superior to commercially available hemp protein concentrates and isolates under the same conditions. The process of the present disclosure unexpectedly resulted in thermal gelling and extrusion of high quality fibrated meat analogs made using only hemp as a protein source. Due to the nature of conventionally used meat and dairy analog proteins, including soy and hemp, conventional meat and dairy analogs cannot reproduce a textured meat filet, such as chicken breast, that is similar to the animal meat product. The unexpectedly advantages properties and results that have resulted from the use of NEPI and the processes of using it described in the present disclosure, a far superior structured meat analog has been created, when compared to other commercially available products, using only hemp protein as a protein source. Hemp protein, to this point, has only been known to be used in combination with soy or other plant proteins to produce a meat analog.

In one aspect, this document features a meat analog extrusion input, or liquid matrix, that may range from about 4:1 to 0.5:1 ratio of protein to fat.

In one aspect, this document features a process wherein water, in ratios as disclosed herein below, is added to a protein isolate, or wherein water is maintained in a protein isolate in a specific ratio, and wherein, after addition, or maintenance, of water with the protein isolate, fat is added to the protein and water mixture in approximately a certain ratio of water to fat and protein to fat.

In one aspect, this document features a product wherein the water content target is between 35 wt % and 75 wt %.

In any of the methods or compositions described herein, the isolated plant protein in the liquid matrix may include a seed oil protein, such as edestin, an albumin, a globulin, or mixtures thereof.

In any of the methods or compositions described herein, the isolated protein may be first isolated from all other plant proteins in the plant.

In any of the methods or compositions described herein, the isolated protein used may have been isolated in a native, or non-denatured, state; wherein native may be mean fully native, substantially native, native in-part, or otherwise identified as substantially native by conventional methods of detecting protein structure, or native as would be understood by a person of ordinary skill in the art.

In any of the methods or compositions described herein, the isolated protein from seed protein preferably has a cysteine content greater than that typically found in soy or casein.

In any of the methods or compositions described herein, the liquid matrix can include a flavoring agent, starch, fiber, or other carbohydrate source

In some embodiments, the meat and dairy analog products provided herein can be free of animal products, wheat gluten, soy protein, or pea protein.

Unless otherwise defined, all technical and scientific terms used herein have the same meaning as commonly understood by one of ordinary skill in the art to which this invention pertains. Although methods and materials similar or equivalent to those described herein can be used to practice the invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting. All references to percent are by weight.

The details of one or more embodiments of the invention are set forth in the accompanying drawings and the description below. Other features, objects, and advantages of the invention will be apparent from the descriptions, drawings and examples and from the claims.

### BRIEF DESCRIPTION OF THE DRAWINGS

FIG. 1 is a flow diagram showing a process for producing a native edestin protein isolate or NEPI in accordance with the present disclosure;

FIG. 2 is a flow diagram showing a process for producing a pasteurized NEPI native edestin protein isolate in accordance with the present disclosure;

FIG. 3 is a flow diagram showing a process for spray drying NEPI in accordance with the present disclosure;

FIG. 4 is a flow diagram showing a process for producing colored NEPI in accordance with the present disclosure;

FIG. 5 is a flow diagram showing a process for extracting hemp oil from hemp grain in accordance with the present disclosure;

FIG. 6 is a flow diagram showing a process for forming hydrosols in accordance with the present disclosure;

FIG. 7 is a flow diagram showing a process for producing a meat and dairy analog by retort in accordance with the present disclosure;

FIG. 8 is a flow diagram showing a process for extrusion of NEPI in accordance with the present disclosure;

FIG. 9 is an SDS-PAGE electrophoresis gel in non-reducing conditions of NEPI protein and hemp protein from commercially available hemp protein concentrates and isolates in accordance with the present disclosure;

FIG. 10 is an SDS-PAGE electrophoresis gel in reducing conditions of NEPI protein and hemp protein from commercially available hemp protein concentrates and isolates in accordance with the present disclosure;

FIG. 11A is an SDS-PAGE electrophoresis gel in reducing conditions of hemp flour and hemp protein isolate from a prior art publication; FIG. 11B is an SDS-PAGE electrophoresis gel in non-reducing and reducing conditions of hemp protein of hemp protein isolate from a prior art publication;

FIG. 12A is a differential scanning calorimetry thermogram of NEPI 250 hulled hemp grain spray dried powder; FIG. 12B is a differential scanning calorimetry thermogram of NEPI 250 whole hemp grain concentrate (slurry);

FIG. 13A is a differential scanning calorimetry thermogram of VICTORY HEMP hulled hemp grain spray dried powder; FIG. 13B is a differential scanning calorimetry thermogram of NUTIVA hemp powder;

FIG. 14A is a photograph of a cross section of boiled chicken breast; FIG. 14B is a magnified photograph of a cross section of boiled chicken breast from FIG. 14A; FIG. 14C is a photograph of a magnified cross section of boiled chicken breast from FIG. 14B;

FIG. 15A is a photograph of a cross section of retorted meat analog using NEPI hulled hemp grain concentrate; FIG. 15B is a magnified photograph of a cross section of retorted meat analog using NEPI hulled hemp grain concentrate from FIG. 15A; FIG. 15C is a magnified photograph of a cross section of retorted meat analog using NEPI hulled hemp grain concentrate from FIG. 15B in accordance with the present disclosure;

FIG. 16A is a photograph of a cross section of retorted meat analog using NEPI hulled hemp grain powder; FIG. 16B is a magnified photograph of a cross section of retorted meat analog using NEPI hulled hemp grain powder from FIG. 16A; FIG. 16C is a magnified photograph of a cross section of retorted meat analog using NEPI hulled hemp grain powder from FIG. 16B in accordance with the present disclosure;

FIG. 17A is a photograph of a cross section of retorted meat analog using VICTORY HEMP hulled hemp grain powder; FIG. 17B is a magnified photograph of a cross section of retorted meat analog using VICTORY HEMP hulled hemp grain powder from FIG. 17A; FIG. 17C is a magnified photograph of a cross section of retorted meat analog using VICTORY HEMP hulled hemp grain powder from FIG. 17B in accordance with the present disclosure;

FIG. 18A is a photograph of a cross section of retorted meat analog using HEMPLAND hulled hemp grain powder; FIG. 18B is a magnified photograph of a cross section of retorted meat analog using VICTORY HEMP hulled hemp grain powder from FIG. 18A; FIG. 18C is a magnified photograph of a cross section of retorted meat analog using VICTORY HEMP hulled hemp grain powder from FIG. 18B in accordance with the present disclosure.

FIG. 19 is a photograph of extruded NEPI from hulled powder and a piece of boiled chicken breast to show texture and fibration similarity in accordance with the present disclosure.

### DETAILED DESCRIPTION

Unless otherwise defined, all technical and scientific terms used herein have the same meaning as commonly understood by one of ordinary skill in the art to which this invention pertains. Although methods and materials similar or equivalent to those described herein can be used to practice the invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting. All references to percent are by weight. The details of one or more embodiments of the invention are set forth in the accompanying drawings and the description below. Other features, objects, and advantages of the invention will be apparent from the description and drawings, and from the claims.

In general, the present disclosure provides methods and materials for producing plant based meat or dairy analogs, also referred to herein as structured protein food products, from hemp grain protein. In any of the methods or compositions described herein, and in some embodiments, the extracted protein-containing product may be separated from other hemp grain proteins. In any of the methods or compositions described herein, edestin may be substantially isolated from some, or all, of the other proteins in hemp grain. In any of the methods or compositions described herein, the isolated protein from grain protein preferably has a cysteine content greater than that typically found in soy or casein.

The plant protein used in accordance with the present disclosure may be an isolated plant protein. For the purpose of the present disclosure, a “native” protein is that protein that may have the same tertiary and quaternary structure as in the living and active cell. In some embodiments, a “native” protein may be substantially native. In any of the methods or compositions described herein, the isolated protein may have been isolated in a generally native, substantially native, or non-denatured state. In any of the methods or compositions described herein, the isolated protein used may have been isolated in a native, or non-denatured, state; wherein native may be mean fully native, substantially native, native in-part, or otherwise identified as substantially native by conventional methods of detecting protein structure, or native as would be understood by a person of ordinary skill in the art. Changes and disruption of the subunit structures as well as the tertiary structure may occur with changes in temperature (typically above 41° C.), or contact with aqueous acid or alkali solutions, oxidizing or reducing agents, or organic solvents. Disruption of the quaternary structure renders, or may render, the protein biologically inactive in the living cell. However, the tertiary structure of the released subunits, having a specific shape created by hydrogen bonds, Van der Waals forces, disulfide linkages, may be functionally active and exhibit similar function as in the living cell. One example of this is the lock and key function of enzymes attributed to the tertiary shape of the protein.

Consequently, if the quaternary or tertiary structures are substantially maintained after extraction in the same state as in a living cell, for the purposes of the present disclosure, these may be considered “native” proteins. The present disclosure has found that certain oil grain globular proteins, which may be considered native in the sense that the tertiary structure has not been denatured by changes in temperature (typically above 41° C.), aqueous acid or alkali solutions, oxidizing or reducing agents, or organic solvents, have unique and superior functional properties.

Conventional plant protein extraction processes are known to disrupt the quaternary and tertiary structure of the protein. In some cases, this disruption may cause the functionality of the quaternary or tertiary structure to be lost or reduced. The tertiary structure may be denatured by disruption of functional bonds and forces, including hydrogen bonds, Van der Waals forces, or disulfide linkages, all of which work together to form a specific tertiary protein structure. Changes in the protein environment and mode of denaturation of the tertiary structure may change the tertiary structure or shape of the protein and its bonds, forces, and links.

As used herein, the term “isolated plant protein” indicates that the plant protein, which may include such proteins as edestin, glutelins, albumins, legumins, vicillins, convicillins, glycinins and protein isolates such as from any seed or bean, including soy, pea, lentil and the like or combinations thereof, or plant protein fraction (e.g., a 7S fraction) has been separated from other components of the source material (e.g., other animal, plant, fungal, algal, or bacterial proteins), such that the protein or protein fraction is at least 2% (e.g., at least 5%, 10%, 20%, 25%, 30%, 35%, 40%, 45%, 50%, 55%, 60%, 65%, 70%, 75%, 80%, 85%, 90%, 95%, or 99%) free, by dry weight, of the other components of the source material. For example, an isolated native globular protein having high cysteine content can be used alone or in combination with one or more other proteins (e.g., albumin) or from any other protein source as soy, pea, whey and the like.

In any of the methods or compositions described herein, the fat can be a non-animal fat, an animal fat, or a mixture of non-animal and animal fat. The fat can be an algal oil, a fungal oil, corn oil, olive oil, soy oil, peanut oil, walnut oil, almond oil, sesame oil, cottonseed oil, rapeseed oil, canola oil, safflower oil, sunflower oil, flax seed oil, palm oil, palm kernel oil, coconut oil, ahi oil, babassu oil, shea butter, mango butter, cocoa butter, wheat germ oil, borage oil, black currant oil, sea-buckhorn oil, macadamia oil, saw palmetto oil, conjugated linoleic oil, arachidonic acid enriched oil, docosahexaenoic acid (DHA) enriched oil, eicosapentaenoic acid (EPA) enriched oil, palm stearic acid, sea-buckhorn berry oil, macadamia oil, saw palmetto oil, or rice bran oil; or margarine or other hydrogenated fats. In some embodiments, for example, the fat is algal oil. The fat can contain the flavoring agent and/or the isolated plant protein (e.g., a conglycinin protein). The fat or oil composition of the liquid matrix can be made to preferentially match the saturated and unsaturated composition of the target source material of the analogue.

Thus, in some embodiments, the isolated protein may substantially be a protein, such as native edestin, isolated from hemp grain, or any other grain that may have edestin or edestin like protein. In some embodiments, proteins may be separated on the basis of their molecular weight, for example, by size exclusion chromatography, ultrafiltration through membranes, or density centrifugation. In some embodiments, the proteins can be separated based on their surface charge, for example, by isoelectric precipitation, anion exchange chromatography, or cation exchange chromatography. Proteins also can be separated on the basis of their solubility, for example, by ammonium sulfate precipitation, isoelectric precipitation, surfactants, detergents or solvent extraction, including aqueous extraction. Proteins also can be separated by their affinity to another molecule, using, for example, hydrophobic interaction chromatography, reactive dyes, or hydroxyapatite. Affinity chromatography also can include using antibodies having specific binding affinity for the heme-containing protein, nickel nitroloacetic acid (NTA) for His-tagged recombinant proteins, lectins to bind to sugar moieties on a glycoprotein, or other molecules which specifically binds the protein. In some embodiments, the plant based meats described herein are substantially or entirely composed of ingredients derived from non-animal sources, e.g., plant, fungal, or microbial-based sources. In some embodiments, a plant based meat or plant based dairy product may include one or more animal-based products. For example, a meat replica can be made from a combination of plant based and animal-based sources.

### Definitions

Hemp Seed (HS) is herein generally defined as viable seeds normally used for further propagation and planting. HS may or may not be food grade based on cleaning practices and seed agricultural preservation practices.

Whole Hemp Grain (WHG) is herein generally defined as hemp grain that includes both viable hemp grain and pasteurized hemp grain.

Viable Hemp Grain (VHG) is herein generally defined as viable hemp seeds that have been further cleaned of all dust and foreign material, are food grade suitable, the heart and hull being fully intact.

Pasteurized Hemp Grain (PHG) is herein generally defined as hemp grain that has been treated by heat or irradiation to destroy the viability of the seed.

Defatted Hemp Grain Cake (DHGC) is herein generally defined as the dry solid residuals resulting from the non-aqueous removal of oil from Hemp Grain.

Hemp Grain Oil (HGO) is herein generally defined as a virgin green oil resulting from the non-aqueous extraction of Hemp Grain.

Hemp Grain Oil Sludge (HGOS) is herein generally defined as crude oil sludge slurry resulting from the non-aqueous extraction of oil from Hemp Grain.

Hulled Hemp Grain (HHG) is herein generally defined as equivalent to hemp hearts or hemp nuts; hemp grain in which the outer hull has been removed.

Defatted Hulled Hemp Grain Cake (DHHGC) is herein generally defined as the dry solid residuals resulting from the non-aqueous removal of oil from hulled hemp grain.

Hulled Hemp Grain Oil (HHGO) is herein generally defined as a yellow oil resulting from the non-aqueous extraction of Hulled Hemp Grain.

Hemp Protein Isolate (HPI) is herein generally defined as isolates of albumin, edestin or aggregates thereof.

Aqueous Oil Albumin Emulsion (AOAE) is herein generally defined as the water based emulsion of oil and soluble albumin proteins.

Native edestin protein isolate (NEPI) is herein generally defined as a product of the protein isolation process as disclosed herein, and may refer to NEPI in liquid, slurry and powder form, as would be understood by one of ordinary skill in the art in the appropriate context of its use.

All products described in flow charts may be present in various physical forms, including liquid, gel, or solid as would be understood by one of ordinary skill in the art in the appropriate context of its use.

The present disclosure may relate to a composition containing native edestin protein isolate (NEPI), which contains edestin or edestin-like proteins and methods for extracting and using NEPI to produce meat and dairy analogs. The present disclosure solves the problems of the prior art with regard to hemp protein isolation, raw material input preparation, and processing of the raw material input, in order to produce a superior plant based meat and dairy analog. The composition and process of the present disclosure includes a process for hemp grain protein isolation, pasteurization, sol formation, gel formation, texturization and meat and dairy analog production. The process of the present disclosure results in a meat or dairy analog product having superior properties when compared to existing products or similar products manufactured using known technology.

In addition to protein isolation, this document is based on methods and materials for making plant based products that more closely replicate meat products, including the texture, juiciness, fibrousness and homogeneity in texture of animal meat. A process for producing meat analogs is described herein that may include selection of proteins based on their unfolding, or denaturation, properties and fat holding capacities. Further, the process described herein includes a method of preparing an extrusion mixture, prior to extrusion, that incorporates water and fat into a selected protein in a manner such that the water and fat form a liquid matrix (which may also be referred to herein as a liquid-fat hydrosol, a hydrosol, an extruder or extrusion input, and an input material) with the protein. Still further, the process described herein includes methods of extruding or otherwise heating the liquid matrix. The process of extruding the liquid matrix includes feeding the liquid matrix into a pump at a first end of an extrusion chamber. The liquid matrix is fed into an extrusion chamber of an extruder, wherein the extruder is set for parameters tailored to the liquid matrix.

As disclosed herein, NEPI may be extracted from hemp grain or other grains, nuts or seeds that contain edestin or edestin-like proteins; although it is currently though that hemp grain is the only source of edestin. In one embodiment, the hemp grain is wet milled and subject to aqueous extraction, thereby producing an insoluble edestin-containing extract, which is herein referred to as NEPI, and an aqueous oil albumin emulsion.

The process according to the present disclosure may produce a pasteurized and functional hemp grain protein concentrate, where the concentrate may be a concentrated liquid coming off a production line or from centrifugation and decanting, or a NEPI powder, which, in some embodiments may have a low, or no, amount of trypsin inhibitor and having high nutritional value and functionality. The process may not use isoelectric extraction, alkali or CO2 solubilization methods. A texturizable protein NEPI concentrate or NEPI powder is thought to be produced by an oil extraction and separation of albumin, utilizing the natural pH and oil content of the hemp grain in conjunction with water. The emulsion forming capability of soluble albumin may form an emulsion which may readily be separated from the insoluble edestin by centrifugation. Lyopholisis, pH readjustment and ultrafiltration separation are not required. Additionally, fiber and chlorophyll may be removed during the NEPI process. Maintaining low temperatures, preferably between 33° F. and 38° F., promotes globulin insolubility and also coagulation of the albumin.

One aspect of the present disclosure relates to the isolation of edestin and edestin-like proteins from plant material, including hemp grain. Edestin is found in the hemp plant; particularly the hemp grain. While hemp grain is thought to be the most common, or only, source of edestin, it is possible that other plants may contain edestin.

The edestin extract compositions, or native edestin protein isolate (NEPI), prepared according to the methods of the present disclosure may be used to make protein-containing compositions. NEPI may preferably be comprised of approximately 80% dry basis protein; in some embodiments NEPI may contain at least 65% dry basis protein, and in some embodiments may contain at least 90% dry basis protein. As such, NEPI may be defined as an edestin containing composition produced according to the methods described in the present disclosure resulting in a product having the functional characteristics described in the present disclosure. The aqueous oil albumin emulsion (AOAE) described in the present disclosure may be further processed to produce other plant based products including hemp oil or grain oil and albumin.

The present disclosure may be practiced using suitable grains, seeds or plant material that contain edestin or edestin-like proteins, wherein such edestin-like proteins may be homologous or have similar structure and function.

The grain used in the present disclosure may be substantially full fat plant grain, i.e. grains that have not been defatted, or pressed, prior to milling. In some embodiments, the grain may be partially defatted. A partially defatted grain includes any plant material from which at least a portion of the fat has been removed.

Substantially full fat hemp grains may have a fat (or oil) content of 10% or more fat by weight, as would be known to a person of ordinary skill in the art. In the present disclosure, the terms fat and oil may be used interchangeably. Suitably, the fat content of a substantially full fat grain is at least about 10%, 15%, 20%, 30%, 40% or even 50% by weight. The fat content of hemp grain is typically at least 30%. The fat content of a partially defatted plant material may be greater than about 5%, 10% or 15% fat by weight. After removal of the hull, the edible portion of the hemp grain contains, on average, 46.7% oil and 35.9% protein.

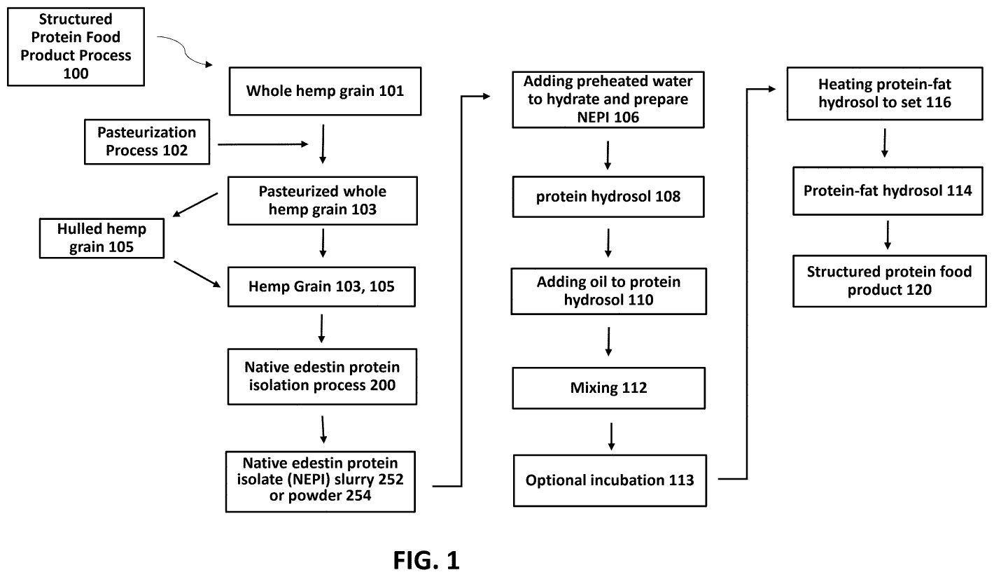

As shown in FIG. 1, hemp grain 102 may be selected for use in a structured protein food product process 100. Whole hemp grain 101 and hulled hemp grain 105 may be used. Pasteurized whole hemp grain 103 may also be used. Hemp grain 102 used according to the present disclosure may be prepared for processing by suitable means, including but not limited to, drying, conditioning to achieve an equilibrated moisture level, dehulling, cracking, and cleaning by counter current air aspiration, screening methods, pasteurizing that does not damage the viable seed, or other methods known in the art. Hemp grain 102 may be selected from of any variety of hemp plant, however, Cannabis Sativa containing not more than 0.3% THC is preferably used in the present disclosure. Hemp grain 102 may be whole hemp grain or hulled (dehulled) hemp grain 102 where hemp grain 102 may be hulled prior to processing in structured protein food product process 100, thereby producing hulled hemp grain 150, as shown in FIG. 4.

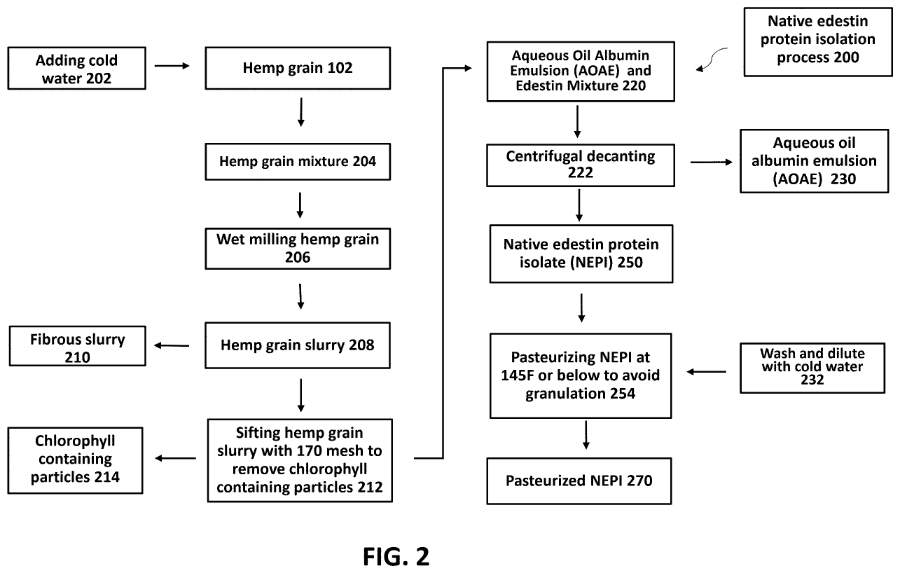

Referring now to FIG. 1, hemp grain 102 in structured protein food product process 100 is subject to native edestin protein isolation process 200 (as shown in FIG. 2) in order to extract native edestin protein isolate (NEPI) 250. Native edestin protein isolate (NEPI) slurry 252 or powder 254, or NEPI 250 may be used to produce structured protein food product 120, which may be a meat or dairy analog. Conventional methods of extracting hemp protein, or edestin, or producing a hemp protein isolate, from hemp grain may result in edestin and albumin aggregation, or protein denaturation, and may not produce a satisfactory structured protein food product or meat analog. NEPI 250, however, is capable of producing a superior, and novel, meat analog when used as the sole protein source in the meat analog, without being combined with soy or other types of plant based protein isolates, as has been described by Zahari (Zahari et al., 2020).

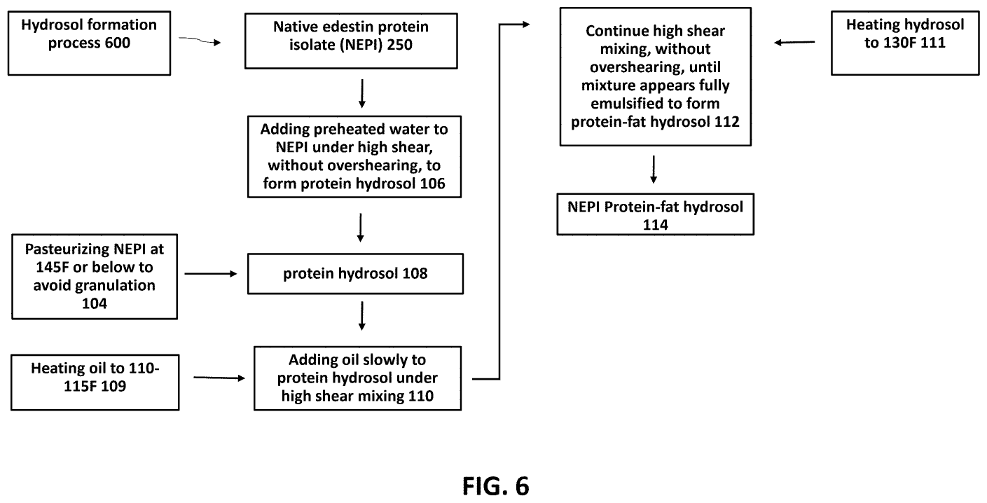

As shown in FIG. 1, NEPI 250 may be, in some embodiments, pasteurized 104 and combined with water 106 to form protein hydrosol 108. NEPI 250 may combined with preheated water 106 to form a protein hydrosol 108 (as shown in FIG. 6). NEPI 250 should be present in at least 20% w/w with water and up to 80% or higher w/w with water. Allow protein to fully hydrate. Hydration time will be dependent on conditions. Mixing at high shear is preferred to promote hydration.

Oil may then be added to the protein hydrosol 110, followed by high shear mixing 112. In some embodiments, after high shear mixing 112 the mixture may be optionally incubated without mixing 113. Addition of oil 110 and mixing 112 produces protein-fat hydrosol 114.

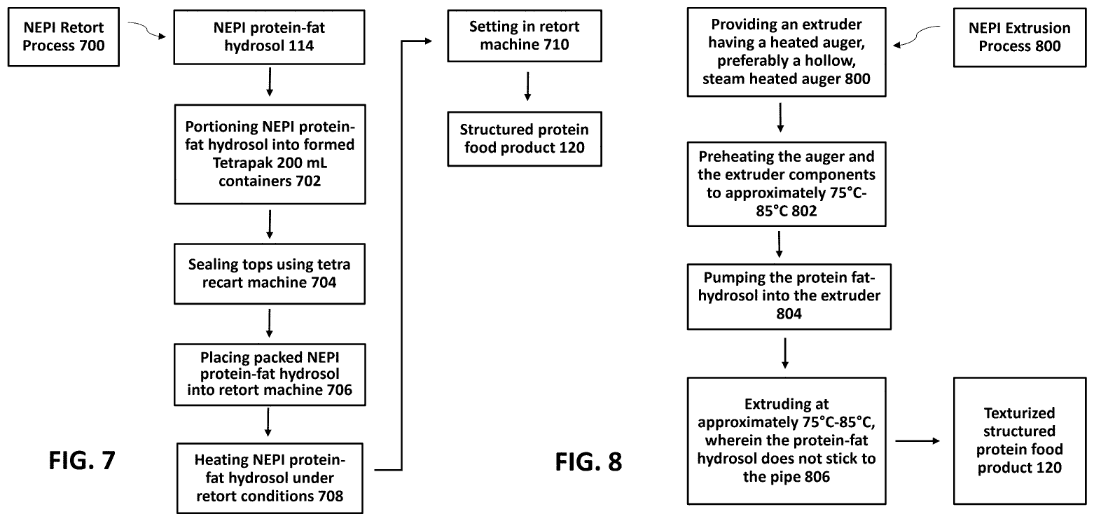

Protein-fat hydrosol 114 is used as an input for a means of heating protein-fat hydrosol to set the product 116. Setting may involve heating through means including microwave, steam tunnels, ovens, retort, and extrusion (as shown in FIGS. 7 and 8). Means of heating to set may include other means of heating protein or starch based food products to form a set, as would be known to one of ordinary skill in the art. Setting protein-fat hydrosol 114 produces structured protein food product 120. Structured protein food product 120 may be a meat or dairy analog.

As shown in FIG. 2, to produce NEPI 250, hemp grain 102 may be added to cold water 202 to form hemp grain slurry 204. The extraction temperature during milling and throughout the native edestin protein isolation process 200 may be more preferably at 35° F., or between 33° F. and 38° F., or less than approximately 120° F., may be added to hemp grain 102 to form hemp grain slurry 204. Hemp grain may be extracted with an aqueous solution, suitably water. As used herein, the term “aqueous solution” includes water substantially free of solutes (e.g., tap water, distilled water or deionized water) and water containing solutes. In accordance with the present disclosure, the aqueous solution may be free of additives such as salts, buffers, acids, bases and demulsifies. In some embodiments, the aqueous solution may have an ionic strength below that which will alter protein structure. More or less water may be used.

In the present process, no adjustment of pH is required to isolate NEPI. Preferably, throughout structured protein food product process 100 the pH remains approximately neutral at between 6.5 and 7. In one embodiment, the pH of the solution does not vary during milling of the grain to any substantial degree.

Hemp grain slurry 204 may be wet milled 206 substantially as described in U.S. Pat. No. 7,678,403 to Mitchell. In one embodiment, milling hemp grain 206 may be performed using a Silverson rotor stator type mill. Wet milling 206 may be performed as part of an aqueous extraction process. Suitably, aqueous wet milling 206 may conducted for a suitable period, and more suitably wet milling 206 is conducted for a suitable period. As one of skill in the art will appreciate, longer extraction periods may be used. In some embodiments enzymes may be used to aid in processing. For example, liquefaction may be accomplished using an alpha-amylase enzyme having dextrinizing activity to yield a liquefied slurry. Such enzymes may include amylase, or other carbohydrases known in the art of food processing. The present disclosure may, in one aspect, utilize a method of aqueous wet milling to separate fat stored within the hemp grain 102 without rupturing the chloroplasts and releasing chlorophyll into the oil. Calcium chloride may be added to NEPI 250 to improve flavor after centrifugal decanting 222.

After aqueous wet milling hemp grain 206, the extract may be separated from at least a portion of an insoluble byproduct or fibrous slurry 210 (e.g., insoluble fiber fraction) with a mesh. In some embodiments, hemp grain slurry 208 may be sifted in two steps. Sifting may remove unwanted impurities that give the edestin unpleasant colors or taste. Insoluble fibers can be removed by a first sifting step. Another undesirable product that may, surprisingly, be removed by sifting without substantially affecting protein yield is chlorophyll from the chloroplasts in the hemp grain and hulled hemp, which can produce unwanted color, taste and fat oxidation in the oil fraction or protein fraction. In some embodiments, chlorophyll containing particles may be removed in a second sifting step 212. After sifting 212 a chloroplast and fiber sludge may be in the retentate, along with raw hemp milk having a fat to protein ration on a DSB of about 1:3:1 in the filtrate.

In a first sifting step, hemp grain slurry may, in some embodiments, be sifted over 30 mesh to remove hulls. The byproduct of the first sifting step may be a fibrous slurry 210. In a second sifting step 212, hemp grain slurry may be sifted 212 to remove chloroplasts with approximately 170 mesh, or in some embodiments between 160 and 200 mesh, or in some embodiments between 200 and 220 mesh to removes chloroplasts, or chlorophyll containing material and any remaining fiber. A mesh size of 150 has openings that may be generally too large and may allow undesirable material into the filtrate, including fibers and chlorophyll-containing particles. Surprisingly, chlorophyll containing particles remain at a size greater than the pore openings of 170 mesh, while most protein containing particles pass through mesh of this size. Sifting with different size mesh separates the chloroplasts, protoplastids or other chlorophyll containing particles from the hemp oil and protein containing fraction, resulting in a pale, yellow final oil product.

Chloroplasts 218 isolated by edestin extraction process 100 may, in some embodiments, be used as a food supplement. According to the process of the present disclosure, chlorophyll containing particles 214 are selectively removed from hemp grain slurry 204 while allowing protein containing particles to pass through into the filtrate. This method is effective for both whole hemp grain, where the hull has not been removed prior to aqueous wet milling and hulled hemp grain.

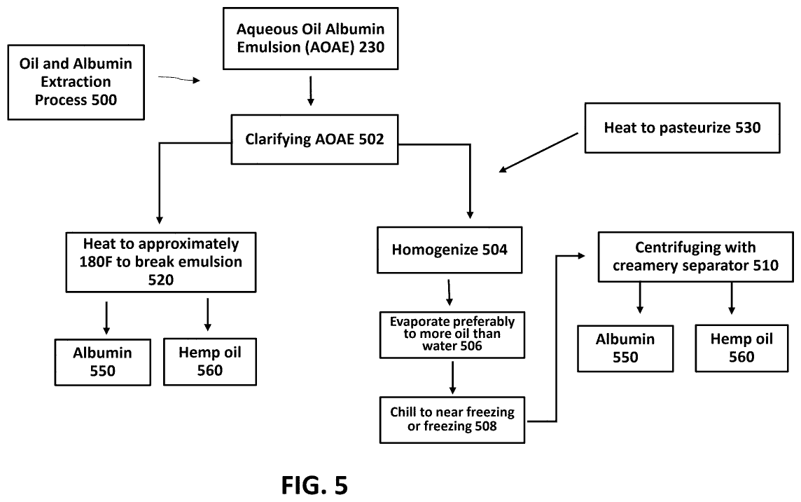

After sifting hemp grain slurry with 170 mesh to remove chlorophyll containing particles 212, the resulting product is an aqueous oil albumin emulsion (AOAE) and edestin mixture 220, which may also comprise other components of hemp grain 102 to greater or lesser degrees. AOAE and edestin mixture 220 may be centrifugally decanted 222, resulting in NEPI 250 and AOAE 230. After being separated from NEPI 250, AOAE 230 may be further processed to produce albumin 550 and hemp oil 518, as shown in FIG. 5.

NEPI 250 may, in some embodiments, be comprised of approximately 76% protein, 2% oil, 4% fibers, 1% carbohydrates and 17% ash. AOAE 220 may be comprised of approximately 14% protein, 76% oil, 3% fiber, 4% carbohydrates, and 3% ash. In some embodiments, NEPI may preferably be comprised of approximately 80% dry basis protein; in some embodiments NEPI may contain at least 65% dry basis protein, and in some embodiments may contain at least 90% dry basis protein. As such, NEPI may be defined as an edestin containing composition produced according to the methods described in the present disclosure resulting in a product having the functional characteristics described in the present disclosure. In some embodiments, NEPI may contain at least about 65%, 75%, 85% or 90% protein on a dry weight basis.

Table 2 shows proximate analysis data of the nutrient composition of NEPI 250 and commercially available hemp protein products. Table 2 shows that the NEPI 250 products have high protein content and protein to fat ratios, as does VICTORY HEMP. The other commercially available products have much lower protein contents and protein to fat ratios. This indicates that of the products tested, NEPI 250 and VICTORY HEMP are likely far superior to the other products.

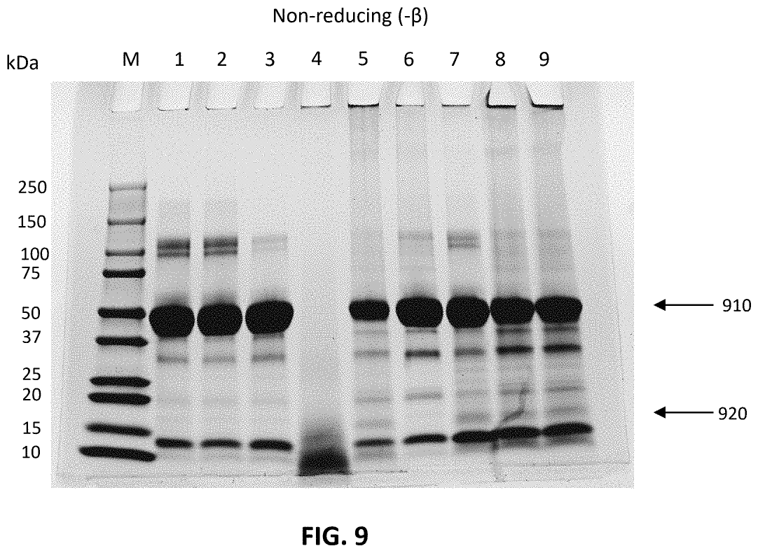

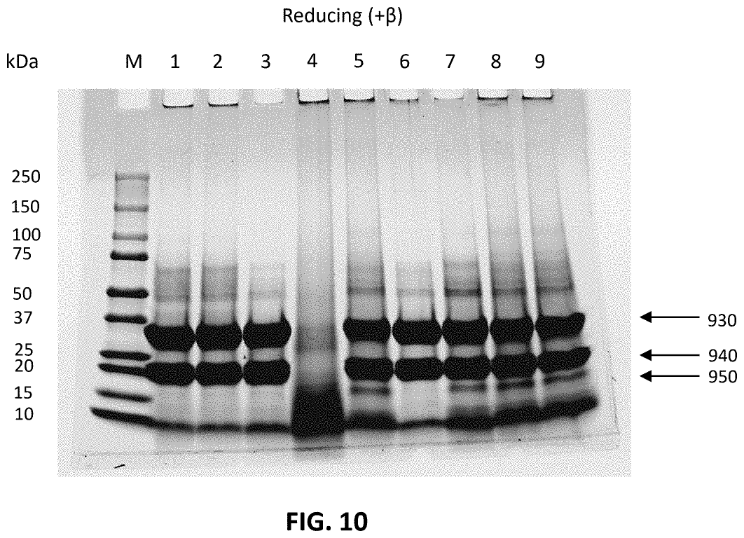

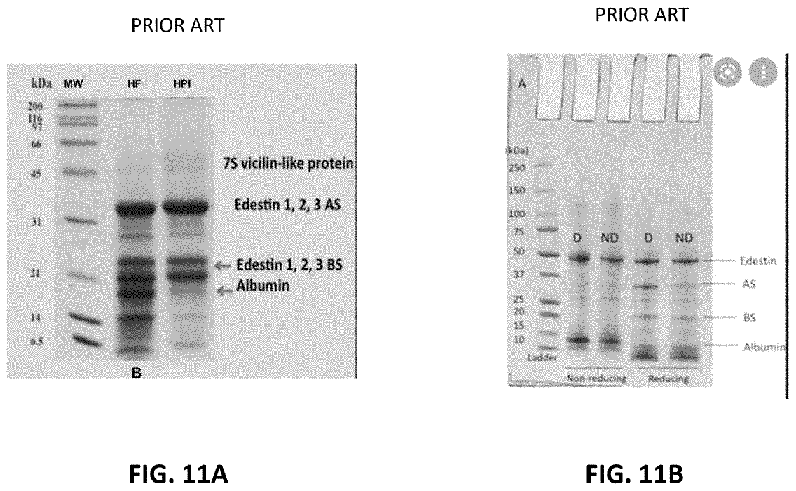

FIGS. 9-11 show SDS PAGE gel data for NEPI 250 products and commercially available products that indicate protein composition, structure and integrity (non-reducing conditions are shown in FIG. 9; reducing conditions are shown in FIG. 10). With regard to FIG. 9, 910 is the edestin dimer and 920 is albumin. With regard to FIG. 10, 930 is the edestin acidic subunit, 940 is the edestin basic subunit and 950 is albumin. FIG. 11 shows prior art SDS PAGE data illustrating known molecular weights for edestin and edestin products under similar conditions. Lanes are identified below, and apply to FIGS. 9 and 10:

M=Molecular weight standard

### 1=DP-276 HempLife pwd SD HPI

### 2=DP-276 HempLife pwd SD HPI

3=DC-344 HempLife liq. conc. HPI

### 4=GH-350 Good Hemp pwd HPI

### 5=A-560 Anthony's pwd HPC

### 6=LP-643 Hulled HempLife SD pwd HPI

### 7=VH-794 Victory Hemp pwd V70 HPI

### 8=N-950 Nutiva pwd HPC

### 9=N-950 Nutiva pwd HPC

FIG. 11A shows prior art SDS PAGE from hemp protein published by Mamone and Wang (Mamone et al., 2019; from Wang and Xiong, 2019). FIG. 11B shows prior art SDS PAGE from hemp protein published by Shen (Shen et al., 2020).

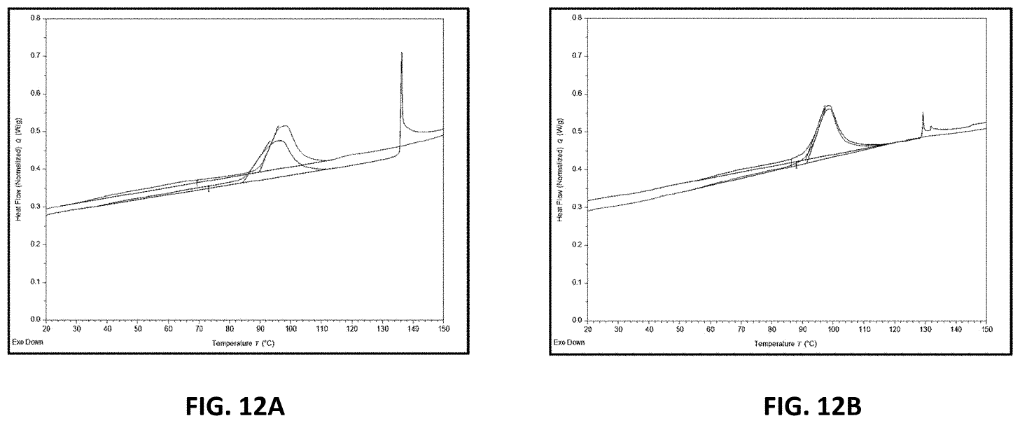

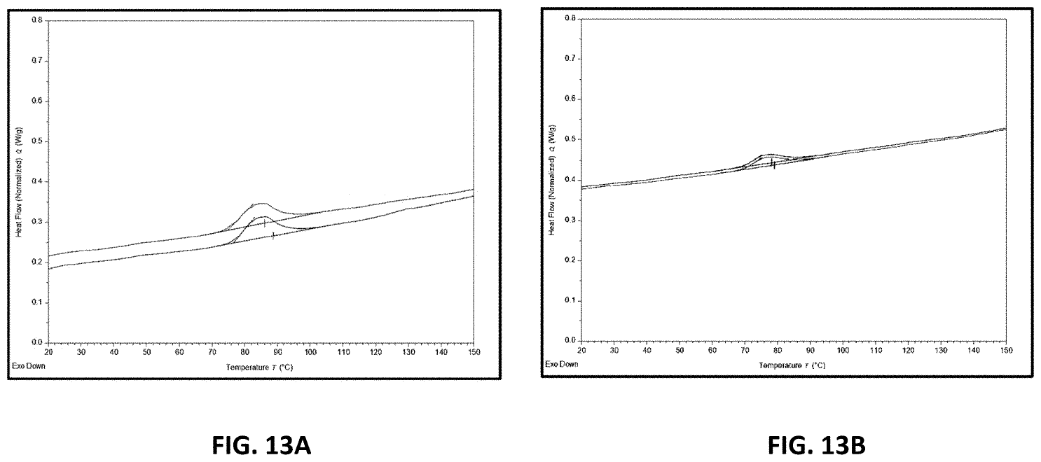

Collectively, FIGS. 9-10 show that NEPI 250 products have a different protein composition than other commercially available products and are generally structurally more intact, with VICTORY HEMP being the closest in terms of native edestin content and non-degraded protein products. Interestingly, as predicted, NEPI 250 products contained substantially no albumin. It is hypothesized in the present disclosure that albumin interferes with the ability of hemp protein isolates to form good structured protein food products 120 having superior textural properties. This theory is supported by the texture profile analysis data shown in Table 2, where the NEPI products have far greater hardness and chewiness, when compared to commercially available hemp protein products. It is also possible that the superior native structural features of the edestin in NEPI 250 contributes to the formation of the unexpectedly superior textural properties of NEPI 250 shown in Table 2. The superior structural preservation of the native state of edestin is further shown in Table 3 and FIGS. 12 and 13, which show differential scanning calorimetry data for the products.

Table 3 shows differential scanning calorimetry thermographs that provide structural information regarding the edestin contained in the NEPI 250 and commercially available products. DSC thermographs for two NEPI products (FIG. 12) and two commercially available hemp protein powders, VICTORY HEMP and NUTIVA (FIG. 13). Based on the DSC results, NEPI products were superior, in terms of structure, when compared to the commercially available products, and indicate that the edestin in NEPI 250 is in a more native state than the commercially available products.

When compared to hemp protein isolates produced by conventional means, as described previously in the background, the quality of the edestin in NEPI 250 is superior. Additionally, when compared to the process of the present disclosure, prior art methods of protein extraction have significant disadvantages and limitations. For example, salt extraction and dialysis in the HMI process does not remove residual phenolics from the final product. Further, HMI is less commercially viable.

The process of the present disclosure has numerous advantages over the prior art. The present process may release phenolics and tocopherols from NEPI 250 and AOAE 230. The process of the present disclosure may make hemp oil 518 more oxidatively stable. In the process of the present disclosure, during aqueous wet milling, phenolics may separate with hemp oil 518, thereby providing stability.

The process of the present disclosure differs from conventional methods of protein extraction from hemp grain in that conventional methods generally involve pressing the grain to extract the oil and produce a hemp grain cake, which may then be milled and sifted to produce a flour. The resulting cake or flour may contain aggregated edestin and albumin, along with oil, carbohydrates, phenolics and minerals. The seed may, in some cases, also be dry milled directly produce a flour.

Mechanical processes that result in high heat or pressure, such as pressing the grain, may lead to chemical bonds being formed between edestin and albumin. Pressing either whole hemp grain or hulled hemp grain may result in aggregation of edestin and albumin.

High pressure can change protein structure and cause protein aggregation. According to Yang, high-pressure modification of proteins involves changes in protein secondary, tertiary, and quaternary structures from the native state through intermediate states to the fully denatured state (Yang et al., 2016). High pressure changes protein structure primarily through changes in non-covalent bond-electronic interactions, hydrophobic interactions, and hydrogen bonds. High pressure can also cause new disulfide bonds to form, thereby stabilizing the denatured proteins or producing protein aggregation (Yang et al., 2016).

Heat, also, is known to alter protein structure. Heat caused by friction during milling of the grain can lead to changes in protein structure. Heat can lead to denaturation of proteins and formation of protein aggregates. Aggregation between edestin and albumin is likely to occur during dry milling, where temperatures can reach 100° C. or higher.

NEPI may, in one embodiment, then be heated to a temperature of approximately 145° F. for approximately 30 minutes to pasteurize the product. In some jurisdictions, 145° F. may be a legal lower limit for pasteurization. In one embodiment, the temperature may be maintained at approximately 145° F., or between 145° F. to 155° F., in order to prevent granulation. Formation of granules has been observed in the present disclosure to occur at temperatures of approximately 158° F. Granulation may occur in NEPI at temperatures well below the denaturation temperature of edestin, for example at approximately 158° F., wherein the denaturation temperature of edestin has been shown to be approximately 95° C. It is critical to pasteurize NEPI at temperatures below those typically used by those of ordinary skill in the art for pasteurization of plant proteins for use in food products. Those of ordinary skill in the art conventionally pasteurize protein isolates at temperatures that would cause significant granulation in the present disclosure, in order to rapidly process the product. Pasteurized NEPI 270 is the result of washing and diluting with cold water 232.

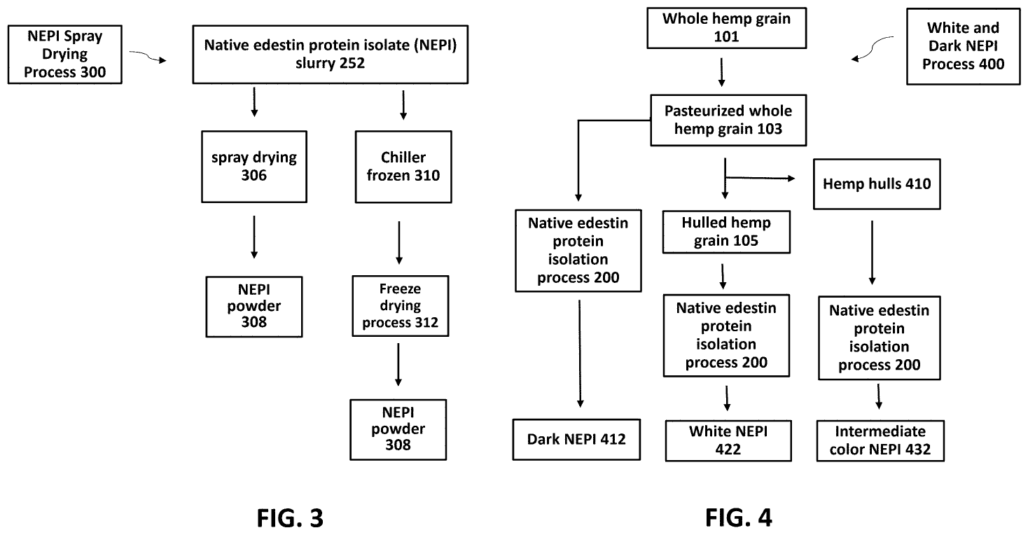

As shown in FIG. 3, after pasteurization 104 is complete, NEPI 250 may be spray dried by NEPI spray drying process 300 or stored cold as a concentrate for use in the production of structured protein food products 120. Just after the centrifugal decanter separation, the solids of the NEPI concentrate range from about 35% to 45% and is a thick paste that is difficult to pump. Cold water is added at this point to reduce the solids of the NEPI 250 concentrate to preferably about 30% to enable ease of pumping the slurry quickly through heated pipes maintained at temeprtures that do not exceed 158 F. the dilution allows for a more turbulent flow and better heat distribution for heating to 145 F and allowing pasteurization without formation of overheated protein aggregates and granules that are undesirable in the finished dried edestin product. Prior to spray drying NEPI concentrate may be held at approximately 145° F., or pasteurization 104 temperatures, in a tank prior to spray drying. Spray drying 306 may then be performed at Higher spray drying 306 temperatures, or temperatures in which the exiting products can reach approximately 158° F. and above, may cause protein agglomeration and result in functionally inferior NEPI 250. This protein agglomeration may be visible on a non-reducing SDS-PAGE gel at approximately 100 kDa (shown in FIG. 9), where bands other than the expected edestin, or hemp grain protein, bands are visible. Bands present at high molecular weight, above the approximately 50 kDa band expected for the edestin dimer, in non-reducing conditions may represent agglomeration caused by excessive heat during spray drying 300. Therefore, in some embodiments, one potential method of measuring whether a maximum temperature of spray drying 300 is below a temperature at which significant protein agglomeration occurs, may be to identify unexpected high molecular weight bands on a non-reducing SDS-PAGE gel. Microwave drying is another method that may be used with the present disclosure, where the NEPI 250 is kept at a low temperature during microwave drying, such as between 130 F and 140 F, while moisture is removed under vacuum pressure.

FIG. 4 shows a process for adding color to structured protein food product 120. White and dark meat analog process 400 may produce either white meat NEPI 412, which may replicate chicken or fish, and dark meat NEPI 422, which may replicate beef or dark meat chicken. To produce white NEPI 422, hulled hemp grain 105 may be used. In one embodiment, hulled hemp grain 105 may be subjected to native edestin protein isolation process 200, which results in white meat NEPI 412, which may be used in structured protein food product process 100 to produce a white meat replica. To produce dark meat NEPI 412, whole hemp grain 101 may be used. In one embodiment, whole hemp grain 101 may be subjected to native edestin protein isolation process 200, which results in dark meat NEPI 412, which may be used in structured protein food product process 100 to produce a dark meat replica. Use of part whole hemp grain and part hulled hemp grain, in one embodiment, wherein the whole hemp grain is used in a concentration of about 20-30% by weight, relative to the amount of hulled hemp grain, may result in a dark NEPI 412 or intermediate colored NEPI 432. In one embodiment, hulls that have been previously removed by dehulling of hemp grain, may be reintroduced to the hulled hemp grain 105 to add dark meat color; where, in one embodiment, to achieve a dark meat color, hulls may be added to hulled hemp grain 105 in an amount of approximately 10-15% by weight relative to the hulled hemp grain to produce intermediate colored NEPI 422.

FIG. 5 shows a process for oil and albumin extraction 500. AOAE 230 that is a product of native edestin protein isolation process 200 may be process to produce albumin 550 and hemp oil 518. In oil and albumin extraction process 500, AOAE 230 may be evaporated to concentrate 504. The product may be homogenized 504 and heated to pasteurize 530. Clarifying AOAE may be useful. Heating to 180 F 520 may break down the emulsion. Evaporate preferably to more oil than water 506. Chill to near freezing or freezing 508. Centrifuging with creamery separator 510 to get albumin 550 or hemp oil 560.

FIG. 6 shows hydrosol formation process 600, in which NEPI 250 may be combined with preheated water to form protein hydrosol 108, which was substantially described in FIG. 2. In hydrosol formation process 600, preheated water at approximately 135° F. may be added to NEPI 250 and mixed under high shear 106 to form protein hydrosol 108. Protein hydrosol may be pasteurized at may be pasteurized at 145° F. before, during or after protein hydrosol formation. Pasteurization conditions should be maintained or created after production of NEPI 250. A pasteurized 104 product may be prepared by first hydrating the NEPI 250, if spray dried 306 to form NEPI powder 308, or otherwise maintaining an appropriate degree of hydration for NEPI 250 and maintaining pasteurizing conditions to the greatest extent possible. In one embodiment, the amount of preheated water added to NEPI 250 may bring the solution to approximately 3 parts water to 1 part NEPI by dry solid weight. In some embodiment NEPI may be frozen in the chiller 310, freeze dried 312 to produce NEPI powder 308. Heating hydrosol to 130 F 111 may be useful. Heating oil to 110-115 F may be useful.

In some embodiments, the preheated water may be tap water, and in some embodiments may be tap water supplied from Lake Erie and may be substantially free of solutes (e.g., tap water, distilled water or deionized water). Salt should not be added to the solution during the hydration and protein preparation process, as it may disrupt protein hydrosol 108 or protein-fat hydrosol 114 structure. Salt may be added after setting, but not before. In some embodiments, protein hydration and opening (such that, without being bound by theory, protein structure may be slightly altered, or opened, to allow appropriate interaction with oil during formation of the protein-fat hydrosol 114) which may be performed at 100° F. to 135° F., or in some embodiments between 100° F. and 155° F.; or in other embodiments protein hydrosol formation may be performed at lower temperatures, however, the temperatures must be above cold temperatures which do not allow for protein hydration and opening. Preferably, temperatures during the hydration and protein-preparation step should remain as close to 145° F., or pasteurization 104 temperature, as possible, without reaching temperatures that may results in protein aggregation and granulation. Once protein hydrosol is formed, preheated oil 109, which may be heated, in some embodiments to between 110° F. to 115° F., and in other embodiments to between 100° F. and 155° F., or in some cases kept at a temperature above that considered cold, such that protein hydrosol structure is disrupted by addition of oil. produce granulation of protein-fat hydrosol 114.

In some embodiments, protein-fat hydrosol 114 can be produced by combining a fat with a warmed suspension of hydrated protein (for example, a protein isolate containing edestin) having a pH between 6.5 and pH 7.8 (for example, pH 7.5). Rapid agitation, such as in a Waring type blender or a hand held homogenizer, or homogenization of this mixture leads to the formation of an emulsion. Physical properties of these protein-fat hydrosol 114 may be controlled by changing protein type, protein concentration, pH level at the time of homogenization, speed of homogenization and fat-to-water ratio.

To form protein-fat hydrosol 114, a polyunsaturated fatty acid (PUFA) oil, or fat, which may preferably be coconut oil or fat, may be heated just past the melting point of the fat, and added to protein hydrosol 108. Without being bound by theory, the fat may form a layer surrounding the hydrated native edestin, thereby forming a liquid matrix, or protein-fat hydrosol 114, that essentially encapsulates the hydrated protein, forming a hydrated protein in oil emulsion which effectively creates a thick and stable gel. Effectively, the oil may seal and protect the hydrated protein structure. Hydrated protein can hold considerably more fat in a gel state than a dry protein. In general, it has been found that a native globular protein, as discussed in this application, that is first hydrated and then gently heated to below its denaturation temperature, may hold up to two times its weight in fat. The moisture content of protein-fat hydrosol may, in some embodiments, range from about 30 wt % to about 70 wt %. The moisture content refers to the amount of moisture in a material as measured by an analytical method calculated as percentage change in mass following the evaporation of water from a sample.

In any of the methods or compositions described herein, protein-fat hydrosol 114 may include a flavoring agent or other additional ingredients. The following ingredients may be added optionally at typically less than 2 wt % on a finished protein-fat hydrosol 114 basis: fat soluble or other flavor systems, salts including sodium chloride, plant based albumin sources, plant based insoluble or soluble fibers. Starch may be added alone or in combination with other soluble carbohydrates including complex carbohydrates or sugars if desired at levels up to about 10 wt % but more preferably less than 5 wt %. The adjunct ingredients may be added to protein-fat hydrosol 114 prior to the set for the purpose of improving and altering flavor or texture. Fiber may be added to decrease “squeakiness” of the structured protein food product 120.

In one embodiment, protein-fat hydrosol 114 may include, in one aspect, about 15 wt % to about 25 wt %, or more preferably about 18 wt % to about 22 wt %, by weight of a protein, wherein the protein may be a native oil seed protein; wherein in one embodiment about 75 wt % to about 85 wt % of the protein isolate comprises a globular protein, and preferably the protein isolate comprises less than 15 wt % albumin, and more preferably less than 5 wt % albumin. More importantly, the globular protein may be in its native state and preferably having a significant content of the amino acid cysteine, in an amount greater than casein or soy protein isolate. The balance of the protein composition may, in some embodiments, be primarily minerals such as calcium and phosphorus. The native oil seed globular protein preferably may have substantial amounts of cysteine.

Protein-fat hydrosol 114 may include, in one aspect, about 40% to about 70%, or more preferably 40%-60%, by weight of a water.

Protein-fat hydrosol 114 may include, in one aspect, about 0% to about 35% by weight of fat; the ratio of saturated to polyunsaturated fatty acid (PUFA) being between 100 wt % saturated fat and 100 wt % PUFA. Combinations between these two amounts of fats provide a variety of unique textures heretofore not reported, depending on the amount of protein used in combination with the fat.

Protein-fat hydrosol 114 may optionally include, in some embodiments, about 0% to about 5% by weight of a starch. The amount of starch added may be dependent on the amount of water added, beyond the amount of water added to the protein that is required for hydration of the protein.

Protein-fat hydrosol 114 may be formed by mixing, manually or mechanically, the ingredients for forming protein-fat hydrosol 114. Preferably, the hydrated protein is first warmed to just below the granulation temperature of the protein, the oil and/or melted fat is added, and preferably the mixture is gently homogenized.

In one aspect, protein-fat hydrosol 114 may be combined at a temperature of between 120° F. and 150° F. The temperature range to set the protein in a heated environment, without disruption of the formed gel or matrix, has been found to be between 70° C. and 100° C. These temperatures are significantly lower than the extrusion temperatures generally required for the extrusion of conventional meat analog proteins, such as soy. The temperature of denaturation and fibration of soy protein under conditions typically used in extruders is in the range of approximately 130° C. to 140° C. According to the present disclosure, good texturization may be obtained by oven heating of the protein-fat hydrosol 114, and/or by pressure cooking (retorting) the protein-fat hydrosol 114 to actively set the protein.

The physical properties of protein-fat hydrosol 114 are that of a hydrosol. The viscosity is dependent on the oil, fat and water and protein content. Variations of higher moisture and will reduce the viscosity substantially even with low protein to fat ratio. Likewise, very low protein to fat ratio and low moisture can result in a very high viscosity. The quality and choice of fat systems and protein systems also significantly impact the viscosity.

Formation of the protein-fat hydrosol 114 can be done below the denaturation point of the native protein. However, according to the present disclosure, it is not desirable to store the protein-fat hydrosol 114 at that temperature, as it is not microbiologically stable. It is preferable to immediately process by heat to set the protein shape. The liquid matrix can otherwise be cooled via heat exchanger or other method to below 6° C. to store prior to further processing.

FIG. 7 shows a retort process for NEPI 770 that results in structured protein food product 120. NEPI protein-fat hydrosol 114 is portioned into formed Tetrapak 200 mL containers 702, in one embodiment, filling each container with 180 g. Tops may be sealed using tetra recart machine 704. Packed NEPI protein-fat hydrosol may be placed into retort machine 706. NEPI protein-fat hydrosol may then be heated under retort conditions 708 to set 710. In some embodiments, this process results in structured protein food product 120.

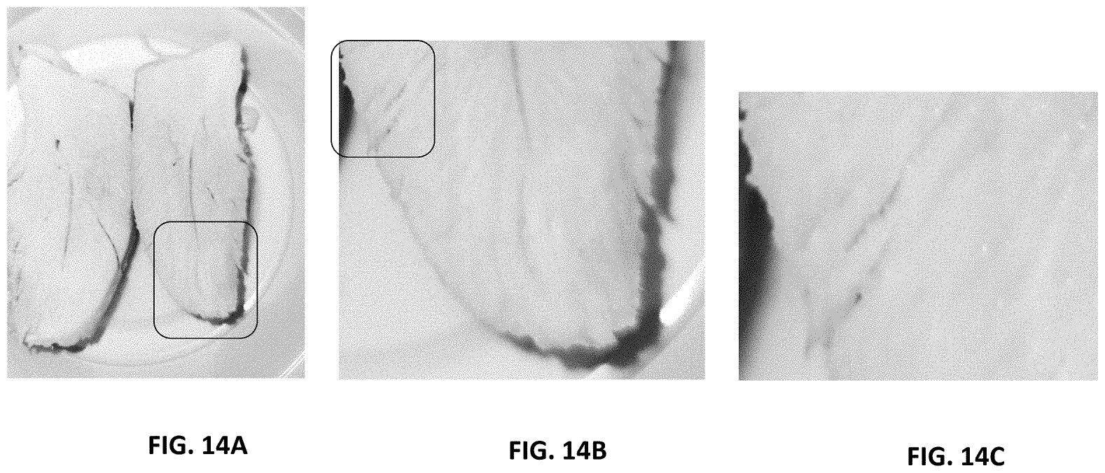

With regard to retort according to the present disclosure, FIGS. 14-18 show photographs of the results of a retort of various NEPI products and commercially available hemp protein powders. Each figure contains magnified view of the retorted products. Boiled chicken was used as a standard. Table 6, below, shows the results of texture profile analysis for the retorted hemp products. Tables 7 and 8 show colorimetric data for each product produced by retort and tested, with boiled chicken breast being used as a standard.

FIGS. 14-18 show photographs of retorted NEPI hulled powder 250, wherein the solids are approximately 2:1 protein to fat (NEPI 250 to coconut oil) and the solid to liquid (water) ratio is approximately 2:3. After preparation of the protein-fat hydrogel, the retorted product was produced as would be known to one of ordinary skill in the art.

FIG. 14A is a photograph of a cross section of boiled chicken breast; FIG. 14A is a magnified photograph of a cross section of boiled chicken breast from FIG. 14A; FIG. 14C is a photograph of a magnified cross section of boiled chicken breast from FIG. 14B;

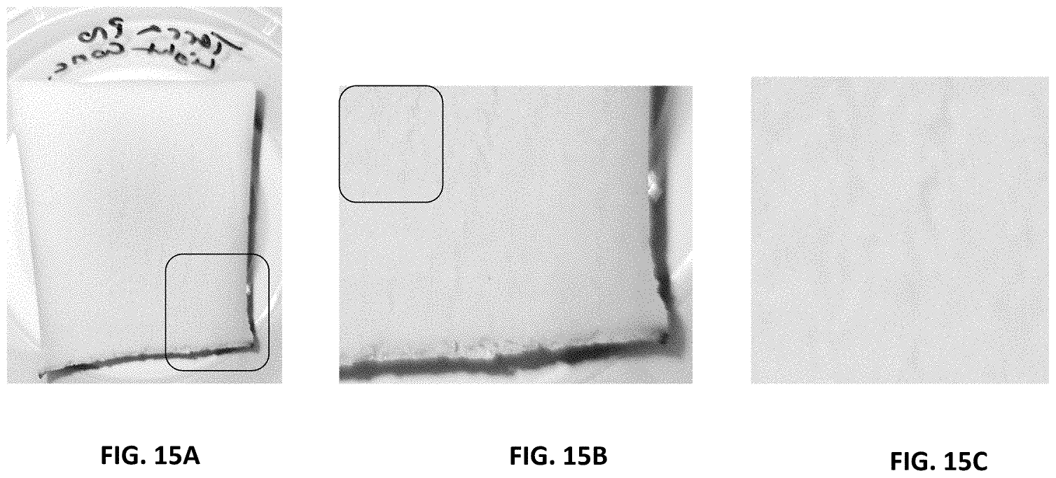

FIG. 15A is a photograph of a cross section of retorted meat analog using NEPI hulled hemp grain concentrate; FIG. 15B is a magnified photograph of a cross section of retorted meat analog using NEPI hulled hemp grain concentrate from FIG. 15A; FIG. 15C is a magnified photograph of a cross section of retorted meat analog using NEPI hulled hemp grain concentrate from FIG. 15B in accordance with the present disclosure;

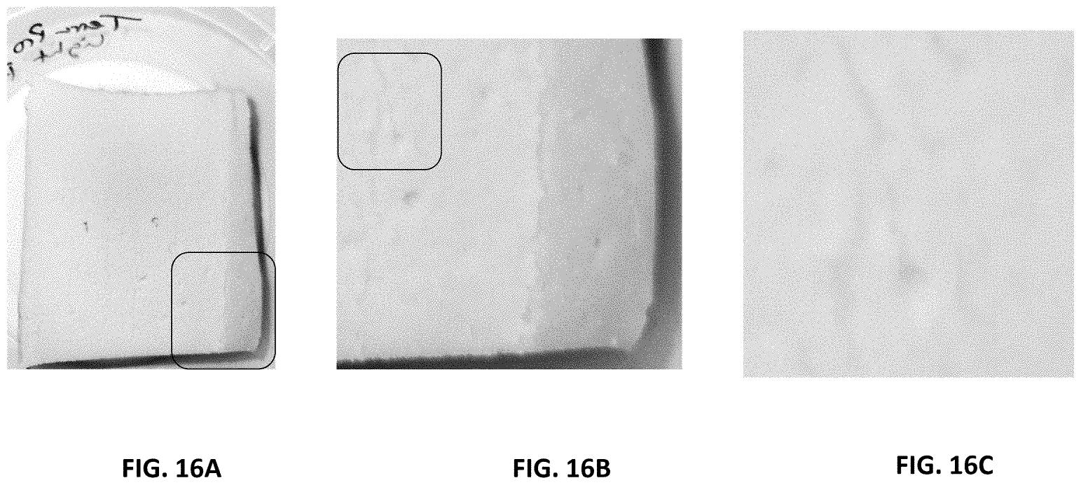

FIG. 16A is a photograph of a cross section of retorted meat analog using NEPI hulled hemp grain powder; FIG. 16B is a magnified photograph of a cross section of retorted meat analog using NEPI hulled hemp grain powder from FIG. 16A; FIG. 16C is a magnified photograph of a cross section of retorted meat analog using NEPI hulled hemp grain powder from FIG. 16B in accordance with the present disclosure;

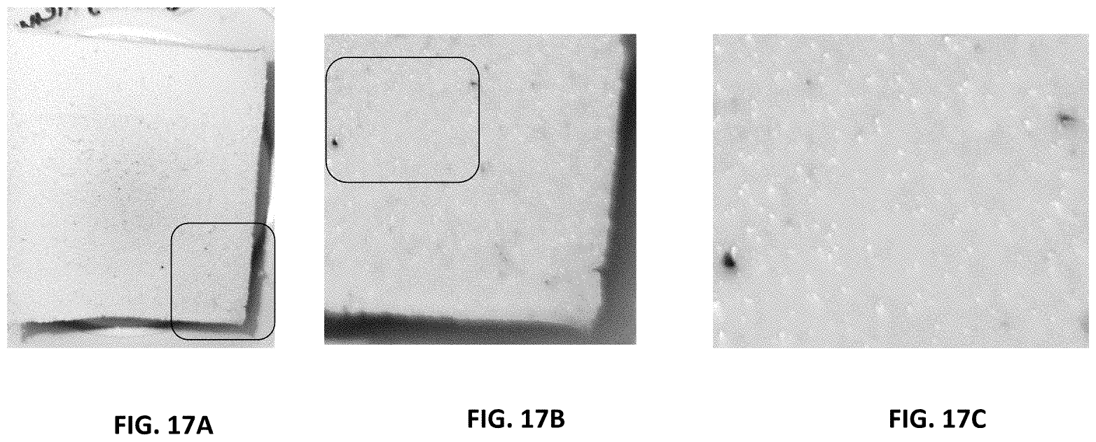

FIG. 17A is a photograph of a cross section of retorted meat analog using VICTORY HEMP hulled hemp grain powder; FIG. 16B is a magnified photograph of a cross section of retorted meat analog using VICTORY HEMP hulled hemp grain powder from FIG. 16A; FIG. 16C is a magnified photograph of a cross section of retorted meat analog using VICTORY HEMP hulled hemp grain powder from FIG. 16B in accordance with the present disclosure;

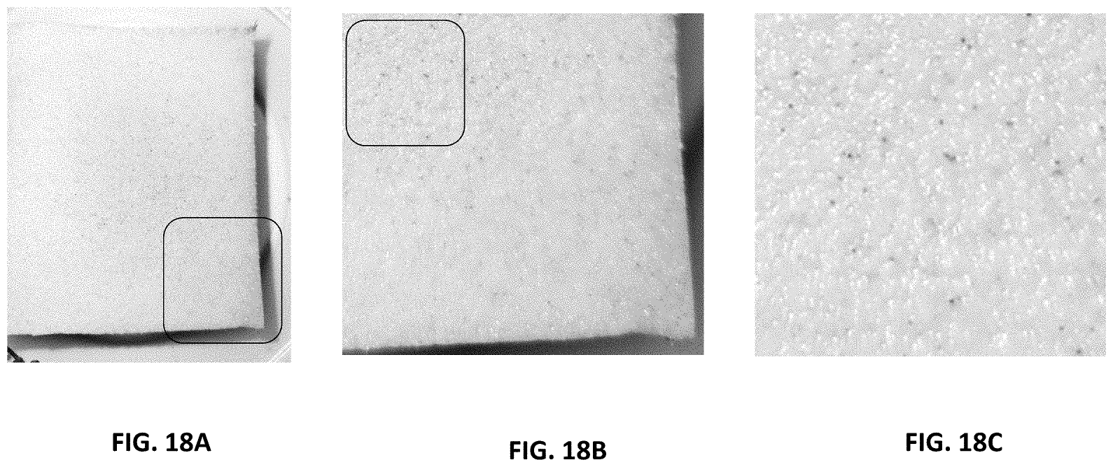

FIG. 18A is a photograph of a cross section of retorted meat analog using HEMPLAND hulled hemp grain powder; FIG. 18B is a magnified photograph of a cross section of retorted meat analog using VICTORY HEMP hulled hemp grain powder from FIG. 18A; FIG. 18C is a magnified photograph of a cross section of retorted meat analog using VICTORY HEMP hulled hemp grain powder from FIG. 18B in accordance with the present disclosure.

FIG. 8 shows a process for extruding NEPI 250 to produce texturized structured protein food product 120. Providing an extruder having a heated auger, preferably, in one embodiment, a hollow, steam heated auger 800, or other type of heated auger extruder. In one embodiment, the extruder may be a POWERHEATER PH 100 provided by SOURCE TECHNOLOGY. Technology used in this machine that may be utilized in the present disclosure may be described in U.S. Pat. And Pat. App. Nos 10,893,688, 10,624,382, 10,149,484, 10,092,013, 10,028,516, 9,931,603, 2010/0062093, 2011/0091627, 2019/0299179, 2020/0113222, 2020/012095, and 2020/02680205 which are herein incorporated in their entirety. The POWERHEATER PH 100 may allow for greater control of the temperature of the auger and inner wall of the extruding pipe or chamber, due to the hollow auger design which allows for steam to be introduced into the auger in order to heat the auger and provide a more uniformly heated protein-fat hydrosol, in the present disclosure, which is critical for proper setting for the present disclosure. Conventional extruders, such as those developed by CLEXTRAL or WENGER, were tested with the present disclosure and did not provide a satisfactory final product. The conventional extruders caused sticking of the protein-fat hydrosol of the present disclosure to the inner wall of the extruder pipe.

The POWERHEATER PH 100, while known to be used with fibrated input material, is generally known to be used to set starch in its input material, rather than protein. Protein-set extrusion is generally performed at temperatures well above 100° C., and therefore protein set input material is not thought to be used with the POWERHEATER PH 100. The protein-fat hydrosol of the present disclosure, however, was effectively texturized and fibrated by the POWERHEATER PH 100 at 75° C., in fibrating the protein-fat hydrosol of the present disclosure, which was accomplished at a relatively low temperature of approximately between 75° C.-85° C., and wherein the auger and extruder may be preheated to between 75° C.-85° C., and extrusion may occur in a range of approximately between 70° C.-95° C. In one embodiment, the protein-fat hydrosol extruder using and 8 mm screw size, rather than a 3 mm screw size, using the POWERHEATER PH 100 at 75° C. The protein-fat hydrosol may be input into the POWERHEATER PH 100 using a sucking pump or a stuffing pump, wherein a the onset temperature may be approximately 85° C. 804. After pumping the protein-fat hydrosol into the extruder 804, extruding at approximately 75° C.-85° C. may proceed, wherein the protein-fat hydrosol does not stick to the inner wall of the extruding pipe 806. This process produces a texturized structured protein food product 120. Texturized structured protein food product 120 extruded in accordance with the present disclosure, in tests, has been demonstrated to have texture, fibration and color similar to that of a cooked chicken breast possesses superior and unexpected properties when considering the prior art and the knowledge of a person of ordinary skill in the art.

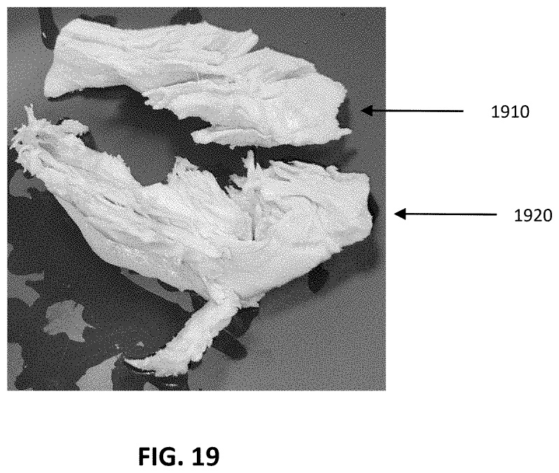

FIG. 19 shows a photograph of extruded NEPI from hulled powder and a piece of boiled chicken breasts to show texture and fibration similarity in accordance with the present disclosure, as extruded on the POWERHEATER PH 100 as described above. Boiled chicken breast 1910 is shown next to an extruded NEPI 250 chicken product 1920 produced from spray dried hulled hemp grain NEPI and processed in accordance with the present disclosure. It is unexpected that hemp grain, using only three ingredients, NEPI 250, coconut oil, and water in a 2:1:3 ratio, respectively.

In most extrusions, including the extrusion of soy based meat analogs, it has been seen that the protein to fat ratio is typically greater than 10:1. As such, extruded, denatured and fibrated soy, can hold very little fat. The hydrated gel of native globular proteins such as edestin, however, according to the present disclosure, can hold up to twice its weight in fat, even after formation of the set, or solid form of the gel, produced by the application of radiant, microwave, or other form of heating, including direct heating or extrusion.

In accordance with the process of the present disclosure, protein-fat hydrosol 114 may be set to a solid state at temperatures of between approximately 70° C. to 100° C., depending on the concentration of the protein in the system. The lower set temperature is consistent with the denaturation of native proteins in NEPI 250.

The solid structure formed during extrusion, according to the present disclosure, may be cooled and is representative of a set, but with incomplete denaturation, similar to an uncooked protein or “raw” meat. Further heating of the “uncooked” protein strengthens the shape, elasticity, texture and the like by further denaturing the protein, a process which ultimately also releases some water. According to the process of the present disclosure, it is undesirable to heat the product to the extent that a significant amount of water is released from the set in the extruder, rather, it is desirable to merely solidify the gel and shape or texture of the protein. In one embodiment, the present disclosure describes a process for preparing a raw meat or dairy analog, or structured protein food product 120, similar to raw animal meat, in the extruder. Further cooking of this raw meat analog, by traditional or commercial means, strengthens and toughens the meat.

The process according to the present disclosure is in contrast to existing technology, in which meat analog texture is created by using fully denatured proteins and then co-blending with other binders including fat, starches, and other proteins to form an appearance of a hamburger type of material. This type of set, according to existing technology, is achieved during cooking primarily through the gelation of starches or added raw proteins such as gluten.

The final texture of the structured protein food product 120 may depend on the properties of the liquid matrix, including the ratios of protein, fat and water, as well as the extrusion conditions. As described herein, the extruded mixture of isolated plant proteins may be referred to as a structured protein food product 120, which may be a meat analog, and the fibrousness and tensile strength of the meat analog may be controlled by co-variation of extrusion parameters such as temperature, pressure, throughput, and die size. For example, combinations of lower extrusion temperatures, medium/low throughputs and smaller dies favor production of highly fibrous tissues with low tensile strength, while higher extrusion temperatures, higher throughputs and larger dies favor production of low fibrousness tissue replicas with very high tensile strengths.

The fibrosity and tensile strength of the meat analog also can be modulated by changing the composition of the extrusion mixture. For example, by increasing the ratio of isolated plant protein to fat and water, or by decreasing water content in the extrusion mixture a meat analog with thinner fibers and larger tensile strength can be made.

Extruding the liquid matrix involves feeding the liquid matrix into an extruder. In some embodiments, the extruder may be a SOURCE TECHNOLOGY POWERHEATER PH 100. CLEXTRAL and WENGER twin screw extruders were tested but provided unsatisfactory results. In extrusion, according to the process of the present disclosure, cooling is important in order to achieve temperatures below 21° C. so that the saturated fats are readily set in the structure and the product can more efficiently be cooled to refrigerated or frozen temperatures.

For each product, the wet ingredient blend will be transferred to a feeder that may meter the liquid matrix through a feed port of an extruder at a certain input rate. In conventional extrusion, a dry protein product is fed into an input in the machine. As the dry product is moved through the machine, and water and fat are introduced from separate inputs. In contrast, during the process according to the present disclosure, the hydrated protein and oil are mixed first, as described herein above, in order to closely regulate the chemical reactions that take place during formation of protein-fat hydrosol 114. Therefore, in some embodiments, additional water, starch, or fat may or may not be added to the extruder during extrusion. Fiber may also be added in some embodiments.

In conventional extrusion of plant based meat analogs, addition of water and fat prior to beginning extrusion may result in an unwanted release of steam as the water escapes from the product as temperature increases. Therefore, the process of adding water and fat is closely regulated during extrusion for the present disclosure. In the process according to the present disclosure, the liquid matrix extrusion mixture is specifically designed to prevent the release of water from the product by the formation of a gel. During preparation of the liquid matrix according to the present disclosure, addition of oil to the hydrated protein forms an emulsion gel that prevents the release of water from the product during extrusion, which would thereby releasing steam from the machine. The formation of the gel also allows for maintenance of high moisture in the liquid matrix during extrusion and in the final product, which is desirable for superior texture of structured protein food product 120.

Temperature during extrusion is important for the resulting product. Temperature should be increased gradually maintained at approximately between 70° C. and 100° C., or between 100° C. and 110° C. In conventional extrusion, temperatures within the extruder are generally above 130° C. In the process of the present disclosure, low temperature prevents disruption of protein-fat hydrosol 114, thereby allowing the molecular structure of the compound to remain substantially, or partially, intact. The temperature of protein-fat hydrosol 114 may be maintained at approximately between 75° C. and 85° C., preferably, to set protein-fat hydrosol 114 and then cooled to reduce the temperature below 21° C. during the extrusion process. For the process of the present disclosure, it is important to maintain a lower temperature than is used during conventional extrusion. Here, the temperature is increased only to a point that allows for setting of the disulfide bonds, such that fat is fully incorporated between all the peptide layers of the protein. The residence time in the extruder or any heating environment, should be enough so that the input temperature of the liquid matrix is able to reach at between 70° C. to 110° C., or preferably between 75° C. and 85° C.

Preferably, the extruder rotates protein-fat hydrosol 114 at a relatively low screw speed, as measured in revolutions per minute (rpm), during extrusion to form a meat analog product that maintains the gel structure and maintains a high degree of moisture in the product. Screw speed may be closely monitored to prevent temperature increases and to prevent disruption of the chemical structure of the liquid matrix.

To prevent the destruction of the structure of a loose protein-fat hydrosol 114 formed by the hydration of the protein and fat encapsulation, it may be essential to move the gel slowly through the heat system to maintain the initial gel set (partial protein denaturation) while forming shape and some fibration. Fermentation (as would occur in cheese manufacture), or full cook and denaturation, would eventually occur during later use of the product. The finished, extruded product, having, in some embodiments, a moisture content of between 35 wt % and 75 wt %, could then be fermented, refrigerated or frozen for microbiological stability until such time that, if desired, it would be fully cooked at higher temperatures by ordinary or commercial cooking processes to obtain the desired finished texture prior to consumption. Additional relevant extrusion parameters may include, die diameter, die length, product temperature at the end of the die, and feed rate.

After extrusion, the final product may have a structure that is that is more similar to animal meat than conventional or known structured protein food products such as meat and dairy analogs. Without being bound by theory, extrusion of protein-fat hydrosol 114, in accordance with the present disclosure, may cause proteins to form substantially aligned protein fibers, where protein fibers may be defined as a continuous filament of discrete length made up of protein held together by intermolecular forces such as disulfide bonds, hydrogen bonds, electrostatic bonds, hydrophobic interactions, peptide strand entanglement, and Maillard reaction chemistry creating covalent cross-links between side chains of proteins. The strength of the set after the initial extruder is not complete or as strong as it could be. In fact, it may be desirable to take the finished heat set product and subject it to further heating by direct or indirect heat, common cookery such as boiling, baking, frying, roasting, microwaving, fermentation and pressing (as in the making of cheese which may include salting and addition of acid) to name a few to finish setting the strength or form of the initial set product.

The preparation and extrusion conditions for protein-fat hydrosol 114, according to the process of the present disclosure, may allow for the substantially aligned protein fibers to, in some embodiments, retain up to approximately 50% by weight of fat within the proteins. Thus, the final product is not greasy and has a mouthfeel and fat release during chewing that more closely matches that of animal meat than existing meat analogs. Mouthfeel may refer to a combination of characteristics including moistness, chewiness, bite force, degradation, and fattiness that together provide a satisfactory sensory experience.

The anticipated final structure of structured protein food product 120 may vary based on the composition of the protein-fat hydrosol 114. The anticipated final composition of structured protein food product 120, in one embodiment of the present disclosure, by weight of protein, weight of carbohydrate (if any), by weight of lipid, and by weight of water, along with any other potential components, is represented in Table 4. Table 5 shows physical properties of for the structured protein food product 120 shown in Table 4. After extrusion is complete, the product may be cooled, shaped or cut. Post-processing steps may be performed on the extruded product.

A meat analog, which may also be referred to herein as a structured protein food product 120, may be produced from protein-fat hydrosol 114 by methods other than extrusion. Additional methods of producing a meat analog from protein-fat hydrosol 114 include the application of mechanical energy (e.g., shearing, pressure, friction), radiation energy (e.g., microwave, electromagnetic), thermal energy (e.g., heating, steam texturizing).

The invention will be further described in the following examples, which do not limit the scope of the invention described in the claims.

### EXAMPLES

### Example 1

### Preparation of Native Edestin Protein Isolate (NEPI)

Hemp grain was obtained from Hemp Oil Canada, Manitoba Canada and River Valley Specialty Farms, Manitoba Canada. Hulled hemp grain was obtained from River Valley Specialty Farms company and whole hemp grain was obtained from Hemp Oil Canada company.

The HHG contained 5.5% % moisture, 46% dry basis Kjeldahl protein, 35% dry basis fat and a 1.3 to 1 protein to fat ratio. The WHG contained 8.8% moisture, 22% dry basis Kjeldahl protein, 30%% dry basis fat and a 0.7 to 1 protein to fat ratio

1000 pounds of the HHG was mixed with 5000 pounds of water at 34° F. in a 800 gallon agitated tank. The HHG was wet milled maintaining the temperature between 34 F and 38 F. The hemp slurry was milled in the Silverson rotor stator tank at a rate of 56 gallons per minute for 30 minutes to wet mill the HHG. The diluted slurry was held for a mean time of 30 minutes. The extract was separated from the insoluble by-product using a mesh of size 120 mesh Sweco 60 inch screen to remove the bulk of the solids. The through of the 120 mesh screen were then passed over a 200 mesh screen on another Sweco vibratory sifter to obtain a slurry that was then transferred to a 500 gallon jacketed tank to maintain the temperature of the slurry at between 34 F and 38 F. The slurry was then fed to a DeLaval centrifugal decanter at a rate of 13 gpm to obtain a separation of the edestin solids from the AOAE emulsion. The AOAE emulsion was then pasteurized through a tubular heat exchanger system at a temperature at a maximum temperature of 185 for 10 minutes. The AOAE was then held in a 900 gallon tank for processing. The edestin solids at 40% solids were diluted with cold water to 30% solids and pumped through a pre-heated tubular system set below 150 F and exited that system at 146 F into a jacketed hold tank having a temperature of 145 F in the jacket. After 30 minutes, the material was cooled through a heat exchanger and to 35 F and placed in a tote in the refrigerator for further processing and drying by a spray dryer.

1000 pounds of the WHG was mixed with 5000 pounds of water at 34° F. in a 800 gallon agitated tank. The HHG was wet milled maintaining the temperature between 34 F and 38 F. The hemp slurry was milled in the Silverson rotor stator tank at a rate of 48 gallons per minute for 30 minutes to wet mill the WHG. The diluted slurry was held for a mean time of 30 minutes. The extract was separated from the insoluble by-product using a mesh of size 60 mesh on a double stage Sweco 60 inch screen to remove the hulls. The second stage of the sweco was fitted with a 200 mesh screen such that the slurry from the Silverson passed first through the 60 mesh removing the hulls and immediately fell on top of the 200 mesh screen which removed the chloroplasts and fine fibers. The rate through the sweco was about 6 gpm and the sifted slurry went directly to a jacketed 500 gallon jacketed tank to maintain the temperature of the slurry at between 34 F and 38 F. When the tank was full, the slurry without hulls, fiber or chloroplasts, was then fed to a DeLaval centrifugal decanter at a rate of 13 gpm to obtain a separation of the edestin solids from the AOAE emulsion. The AOAE emulsion was then pasteurized through a tubular heat exchanger system at a temperature maximum of 185 for 10 minutes. The AOAE was then held in a 900 gallon tank for processing. The light brown colored edestin solids at 40% solids out of the decanter were diluted with cold water to 30% solids and pumped through a pre-heated tubular system set below 150 F and exited that system at 146 F into a jacketed hold tank having a temperature of 145 F in the jacket. After 30 minutes, the material was cooled through a heat exchanger and to 35 F and placed in a tote in the refrigerator for further processing and drying by a spray dryer. The dry substance basis yield of the NEPI based on the WGH weight starting material was 15% or 79% of theoretical. AOAE yield was 25.3% DSB and Hull, Fiber and Chlorplast fraction was 46.9% on a DSB Overall recovery was 92%. The NEPI yield from HHG was 30% or 86% of theoretical. AOAE yield was 40.9% DSB and Hull, Fiber and Chlorplast fraction was 22.5% on a DSB Overall recovery was 98%. Analysis of the NEPI products obtained from the WGH and the HHG are shown in Table 2 below.

TABLE 1
NATIVE EDESTIN PROTEIN ISOLATE COMPOSITION FOR
NON-PASTEURIZED HULLED AND DEHULLED HEMP GRAIN

| | NEPI | NEPI | NEPI | NEPI |
|---|---|---|---|---|
| | Hulled | Hulled | Whole | Whole |
| | Conc. | Powder | Conc. | Powder |
| TOTAL PROTEIN % | 25.54 | 79.25 | 23.98 | 73.38 |
| EDESTIN % | >20.54 | >74.25 | >18.89 | >68.38 |
| ALBUMIN % | <5 | <5 | <5 | <5 |
| CARBOHYD-RATES % | Min. | Min. | Min. | Min. |
| FIBER % | 1.03 | 3.2 | 2.12 | 6.5 |
| MOISTURE % | 70 | 6.9 | 70 | 8.2 |
| FAT % | 0.68 | 2.12 | 0.83 | 2.54 |
| PROTEIN/FAT RATIO | 37.38 | 37.38 | 28.89 | 28.89 |
| TOTAL PLATE COUNT | >56,000 | 30 | 55,000 | 1,453 |

NEPI concentrates prepared by the process of this disclosure even while maintaining process temperatures below 38 F, still exhibit high microbiological activity prior to pasteurization and spray drying to the Powders. (See Table 1). The incoming raw materials whether from hemp grain or hulled hemp have Total Plate Counts (TPC) ranging typically from 2,000 TPC to 250,000 TPC. In an aqueous media that is rich in protein, it is essential to maintain the temperatures well below 42 F and preferably less than 38 F. In spite of the low temperatures, the TPC will continue to increase and result in spoilage of the protein if not pasteurized soon after the aqueous milling begins. The short duration of the process and the ability to pasteurize both the AOAE and the edestin slurry immediately after separation by centrifugal decanter, is an essential factor in the process. The resulting edestin product being pasteurized at low temperatures of 145 F preserve the gelling functionality as previously mentioned. The OAOE can be heated at much higher temperatures in excess of 145 F and more preferably 195 F for short periods of time which is advantageous for further processing to remove remaining insoluble solids via centrifugation and then emulsion disruption to separate the aqueous albumin phase and the oil phase. The success of the pasteurization of the NEPI Product in final powder form is reflected in TPC of the products in Table 1.

TABLE 2
NATIVE EDESTIN PROTEIN ISOLATE (NEPI) AND COMMERCIAL
HEMP PROTEIN PRODUCT COMPOSITIONS

| | | | VICTORY | GOOD | | |
|---|---|---|---|---|---|---|
| | NEPI | NEPI | HEMP ® | HEMP ™ | ANTHONY'S ™ | NUTIVA ® |
| | Whole | Hulled | Hulled | Hemp | Hemp | Hemp |
| | Powder | Powder | Powder | Powder | Powder | Powder |
| PROTEIN % | 79.93 | 85.12 | 78.58 | 72.29 | 46.43 | 55.29 |
| TOTAL SUGARS % | 0.44 | 0.00 | 4.92 | 2.82 | 5.49 | 0.00 |
| CARBOHYDRATES % | 7.52 | 3.44 | 9.01 | 5.77 | 34.95 | 20.35 |
| FIBER % | 7.08 | 3.44 | 4.10 | 2.94 | 29.47 | 20.35 |
| MOISTURE % | 0.00 | 0.00 | 0.00 | 0.00 | 0.00 | 0.00 |
| FAT % | 2.77 | 2.28 | 1.97 | 10.77 | 9.98 | 11.24 |
| PHOSPHORUS % | 3.51 | 3.80 | 3.00 | 3.21 | 1.57 | 1.99 |
| PHOSPHATE % | 10.76 | 11.60 | 9.22 | 9.82 | 4.80 | 6.09 |
| CALCIUM % | 0.44 | 0.36 | 0.10 | 0.21 | 0.16 | 0.19 |
| MAGNESIUM % | 2.06 | 1.74 | 1.53 | 2.10 | 0.64 | 1.05 |
| SULFUR % | 0.74 | 0.74 | 0.84 | 0.69 | 0.50 | 0.58 |
| TOTAL ASH % | 17.28 | 18.23 | 13.36 | 14.16 | 8.83 | 9.85 |
| PROTEIN/FAT RATIO | 28.85 | 37.33 | 39.88 | 6.71 | 4.65 | 4.92 |
| COLOR | Gray | White | White | White | Gray | Gray |
| | | | Speckled | Speckled | Speckled | Speckled |

Table 3 shows DSC thermographs. The structure of NEPI, as measured by DSC thermographs (as partially shown in FIGS. 12A-B and FIG. 13 A-B) may be compared to commercially available products below.

TABLE 3
DIFFERENTIAL SCANNING CALORIMETRY

| | | PEAK | ONSET |
|---|---|---|---|
| | ENTHALPY | TEMPERATURE | TEMPERATURE |
| | (J/g) | (° C.) | (° C.) |
| NEPI | 8.86 ± 0.03 | 96.91 ± 1.44 | 87.02 ± 3.86 |
| Hulled Powder | | | |
| NEPI | 6.04 ± 0.15 | 94.43 ± 0.26 | 85.12 ± 0.58 |
| Whole Powder | | | |
| NEPI | 8.34 ± 0.75 | 98.4 ± 0.01 | 91.27 ± 0.24 |
| Whole Concentrate | | | |
| VICTORY | 3.84 ± 0.13 | 84.55 ± 0.36 | 75.66 ± 1.22 |
| HEMP ® | | | |
| Hulled Powder | | | |
| NUTIVA ® | 1.36 ± 0.02 | 76.56 ± 0.35 | 69.28 ± 0.25 |
| Hemp Powder | | | |
| ANTHONY'S ™ | 0.54 ± 0.02 | 77.37 ± 0.62 | 71.05 ± 0.25 |
| Hemp Powder | | | |
| GOOD HEMP ™ | — | — | — |

Further structural and compositional analysis of the NEPI and the commercially available hemp protein products, as measured by SDS-PAGE gel electrophoresis is shown in FIGS. 9 and 10.

### Example 2

### Spray Drying NEPI

The NEPI refrigerated slurry obtained form Example 1 were sent to a commercial spray dryer for drying. Alfa Laval type spray dryer with nozzles having a 1200 lb per hour water removal capacity was used to dry the powders. The refrigerated product was pumped into a jacketed 250 gallon tank which used a water temperature set to hold the jacket at 155 F. The tank had a slow agitator and the product took several hours to heat approximately 200 gallons of the concentrate edestin slurry at 30%. Once the product achieved temperature it was sent to another tank which fed the dryer. It should be noted that the NEPI dries very easily with no sticking to the walls of the dryer. Final outlet temperature of the dried product was 85 F. The composition of the dry product is given in Table 2 below for each of the NEPI (WG and HHG) products obtained from Example 1.

### Example 3

### Protein-Fat Hydrosol Production from NEPI and Commercial Hemp Powders

Protein Hydrosols are readily made in a 5 gallon plastic bucket by adding 14 lbs of water that had been pre-heated to 140 F. To the water is slowly added 14 lbs of the NEPI dry powder with agitation using a hand held industrial homogenizing wand of ¼ horsepower. Homogenizing is maintained until the all the powder has been added. The temperature, now at 130 F, to which after approximately 15 minutes of holding, is added 7 lbs of canola oil all at once, and the mixture briefly blended with the homogenizing wand for approximately 1 minute or until the slurry appears to be well blended and the oil incorporated as a uniform emulsion.

### Example 4

### Protein-Fat Hydrosol Formulations and Properties for Different Types of Meat and Dairy Analogs

Example 4 discloses formulations comprising the liquid matrix used for producing various types of meat analogs. According to the present disclosure, depending on the ratios of protein, fat and water, different types of meat analog products can result, including plant based meat analog targets that replicate seafood, white meat, dark meat, egg and cheese.

TABLE 4
PROTEIN-FAT HYDROSOL FORMULATIONS FOR DIFFERENT
TYPES OF MEAT AND DAIRY ANALOGS

| | | WHITE | DARK | | |
|---|---|---|---|---|---|
| | SEAFOOD | MEAT | MEAT | EGG | CHEESE |
| WATER (%) | 72.0 | 67.0 | 58.0 | 52.5 | 35.0 |
| NATIVE | 20.0 | 20.0 | 20.0 | 15.0 | 25.0 |
| PROTEIN (%) | | | | | |
| TOTAL FAT (%) | 5.0 | 10.0 | 20.0 | 30.0 | 35.0 |
| SATURATED | (3) | (6.7) | (15) | (24) | (31.5) |
| FAT (%) | | | | | |
| PUFA (%) | (2) | (3.3) | (5) | (6) | (3.5) |
| STARCH (%) | 3.0 | 3.0 | 2.0 | 2.5 | 5.0 |
| TOTAL (%) | 100.0 | 100.0 | 100.0 | 100.0 | 100.0 |
| PROTEIN:FAT | 4:1 | 2:1 | 1:1 | 0.5:1 | 0.7:1 |
| RATIO | | | | | |
| SATURATED | 1.5:1 | 2:1 | 3:1 | 4:1 | 9:1 |
| FAT:PUFA | | | | | |
| RATIO | | | | | |

With regard to Table 4, the water content target is between 35 wt % and 75 wt %. The minimum 70 wt % globular native plant protein having an albumin content of less than 15 wt %, preferably less than 5 wt %. The liquid matrix temperature should be maintained at 140° F. from mix blend through processing. Due to the ability of native seed oil proteins, which in Table 4 may be native edestin, the amount of fat may be varied to obtain different types of meat analog products. The structural features of the resultant products are similar to those of the material that they were duplicating. For example, seafood texture was white in color having a very elastic structure similar to a raw shrimp or scallop. The white meat was white, and had a texture similar to what would be expected of a partially cooked chicken filet. The dark meat was slightly light brown in color and again had the texture similar to a chicken thigh, with more fat and moisture compared to the white meat. The egg was similar to what would be expected for scrambled eggs and was also white in color. The cheese was similar to a cheese curd and actually squeaky when bitten into a piece similar to fresh cheese curds.

TABLE 5
PROTEIN-FAT HYDROSOL FORMULATIONS
AND PHYSICAL PROPERTIES

| | | WHITE | DARK | |
|---|---|---|---|---|
| | SEAFOOD | MEAT | MEAT | CHEESE |
| TOTAL SOLIDS (%) | 33.96 | 38.27 | 31.91 | 41.22 |
| PH | 7.53 | 7.77 | 6.57 | 7.53 |
| VISCOSITY | 260 at | 1740 at | 1200 at | 100 at |
| | 38° F. | 38° F. | 39° F. | 39° F. |
| PROTEIN (%) | 16.6 | 14.59 | 11.4 | 9.88 |
| FAT (%) | 9.5 | 15.49 | 14.77 | 30.06 |

### Example 5

### Production of Structured Protein Food Product by Retort

Retort conditions were over 15 minutes from a temperature of 77 F to a peak of 270 F and decreased to 95 F at 15 minutes. Pressure was 0.20 bar at 1 minute and increased to 3.0 bar at 4 minutes and decreased to 0.8 bar at 15 minutes. The machine used was a Sundry RETORT TYPE: AP-95, SERIAL NUMBERS: 705.

TABLE 6
TEXTURE PROFILE ANALYSIS STRUCTURED PROTEIN FOOD PRODUCT BY RETORT

| | HARDNESS | RESILIENCE | COHESION | SPRINGINESS | GUMMINESS | CHEWINESS |
|---|---|---|---|---|---|---|
| NEPI | 3936.039 ± | 49.101 ± | 0.87 ± | 92.011 ± | 3426.945 ± | 3160.724 ± |
| Hulled | 293.289 | 1.186 | 0.006 | 4.201 | 268.170 | 364.008 |
| Concentrate | | | | | | |
| NEPI | 3101.109 ± | 46.545 ± | 0.861 ± | 91.083 ± | 2669.058 ± | 2417.999 ± |
| Hulled Powder | 402.859 | 1.247 | 0.008 | 6.220 | 323.089 | 140.004 |
| NEPI | 2862.024 ± | 46.730 ± | 0.853 ± | 95.357 ± | 2441.816 ± | 2327.899 ± |
| Whole | 219.876 | 0.863 | 0.006 | 5.126 | 197.409 | 221.988 |
| Concentrate | | | | | | |
| NEPI | 2858.219 ± | 49.928 ± | 0.856 ± | 93.658 ± | 2447.143 ± | 2297.847 ± |
| Whole Powder | 136.060 | 1.002 | 0.007 | 8.669 | 103.468 | 303.165 |
| VICTORY | 1096.057 ± | 47.325 ± | 0.849 ± | 95.981 ± | 930.028 ± | 892.610 ± |
| HEMP ® | 31.667 | 0.578 | 0.008 | 1.518 | 18.149 | 19.848 |
| Hulled Powder | | | | | | |
| HEMP-LAND ™ | 1607.580 ± | 49.430 ± | 0.864 ± | 95.629 ± | 1388.764 ± | 1327.905 ± |
| Hulled Powder | 93.649 | 0.707 | 0.008 | 1.675 | 69.510 | 67.373 |
| NUTIVA ® | 480.590 ± | 38.826 ± | 0.795 ± | 94.653 ± | 381.910 ± | 361.215 ± |
| Hemp Powder | 21.487 | 1.250 | 0.016 | 3.732 | 11.109 | 3.510 |
| ANTHONY'S ™ | 56.722 ± | 24.168 ± | 0.641 ± | 82.527 ± | 36.148 ± | 29.990 ± |
| Hemp Powder | 15.106 | 1.990 | 0.043 | 9.039 | 8.435 | 8.134 |
| NUTRALYS ® | 218.425 ± | 53.277 ± | 0.830 ± | 104.440 ± | 180.527 ± | 185.471 ± |
| F85 Pea | 110.871 | 3.106 | 0.025 | 9.500 | 89.330 | 82.435 |
| Powder | | | | | | |
| DUPONT ® | 906.752 ± | 62.532 ± | 0.918 ± | 92.331 ± | 832.174 ± | 767.714 ± |
| SUPRO ® | 92.852 | 1.326 | 0.007 | 1.205 | 84.316 | 69.009 |
| EX 38 | | | | | | |
| Soy Powder | | | | | | |

TABLE 7
COLORIMETRIC COMPARISON RETORTED
PRODUCT WHITE PLATE STANDARD

| | L* | a* | b* | dE value |
|---|---|---|---|---|
| WHITE PLATE | 94.36 | 0.03 | 2.81 | 0 |
| BOILED CHICKEN | 84.02 | 2.29 | 16.34 | 17.17 |
| BREAST | | | | |
| NEPI | 78.90 | −0.47 | 8.76 | 16.61 |
| Hulled Concentrate | | | | |
| NEPI | 78.68 | 1.10 | 13.08 | 18.71 |
| Hulled Powder | | | | |
| VICTORY | 75.05 | 0.51 | 11.56 | 21.36 |
| HEMP ® | | | | |
| Hulled Powder | | | | |
| HEMP-LAND ™ | 73.04 | 0.42 | 14.11 | 24.13 |
| Hulled Powder | | | | |

### Colorimeter—Chroma Meter CR-400—Konica Minolta 2021 Dec. 3

TABLE 8
COLORIMETRIC COMPARISON RETORTED
PRODUCT BOILED CHICKEN STANDARD

| | L* | a* | b* | dE value |
|---|---|---|---|---|
| BOILED CHICKEN | 84.02 | 2.29 | 16.34 | 0 |
| BREAST | | | | |
| NEPI | 78.90 | −0.47 | 8.76 | 9.55 |
| Hulled Concentrate | | | | |
| NEPI | 78.68 | 1.10 | 13.08 | 6.36 |
| Hulled Powder | | | | |
| VICTORY | 75.05 | 0.51 | 11.56 | 10.10 |
| HEMP ® | | | | |
| Hulled Powder | | | | |
| HEMP-LAND ™ | 73.04 | 0.42 | 14.11 | 11.36 |
| Hulled Powder | | | | |

### Colorimeter—Chroma Meter CR-400—Konica Minolta 2021 Dec. 3

TABLE 9

| | | | | | HEMP- | VICTORY |
|---|---|---|---|---|---|---|
| | NEPI | NEPI | NEPI | NEPI | LAND ™ | HEMP ® |
| | Whole | Whole | Hulled | Hulled | Hulled | Hulled |
| | Conc. | Powder | Conc. | Powder | Powder | Powder |
| Strength (g) | 2010.83 | 2434.64 | 4058.825 | 2650.95 | 948.90 | 456.83 |
| Distance (mm) | 8.62 | 9.79 | 10.58 | 10.11 | 6.95 | 5.21 |
| Toughness | 10245.84 | 12268.16 | 20110.99 | 12892.86 | 5400.93 | 2657.59 |
| (g · sec) | | | | | | |

### Example 6

### Production of Structured Protein Food Product by Extrusion

This hydrogel from Example 3 was used in a Power 100 Source Technology extruder set for 6 lbs a minute flow rate and a 3MM screw auger diameter at 185 F to create a structure gel having the appearance and texture of white meat chicken. See Figure X of a picture comparison of white chicken meat and the Hydrogel Structured Protein Food Product by Extrusion.

The present disclosure unexpectedly demonstrates that a surprisingly superior hemp based structured protein product can be produced using only 3 ingredients: hemp grain, oil, and water. A hemp meat analog produced according to the present disclosure is herein shown to replicate chicken in terms of color, texture and taste to a surprising degree. Commercially available protein products, some of which claim to produce excellent meat analogs, did not compare to the native edestin protein isolate in terms of taste, color or texture, when used for this purpose.

No commercially available products were uncovered that used only hemp protein to produce a meat analog. Further, the prior art teaches that hemp protein alone is not a viable protein for producing structured protein food products such as meat and dairy analogs. The present disclosure demonstrates that this is not the case.

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A process comprising:
selecting a hemp grain;
aqueous wet milling the hemp grain at low temperature to produce a hemp grain slurry;
sifting the hemp grain slurry at a mesh size of between 160 and 200 to remove chlorophyll containing particles from the hemp grain slurry without substantially reducing a protein yield;
substantially separating the insoluble material from the soluble material in the sifted hemp grain slurry by centrifugal decanting to produce a native edestin protein isolate and an albumin oil aqueous emulsion;
providing water to maintain the native edestin protein isolate is above a solids content of about 20% w/w and mixing to form a protein hydrosol;
heat pasteurizing the native edestin protein isolate at a temperature below 155° F. to avoid granulation;
combining the native edestin protein isolate with an oil to form a protein-fat hydrosol while maintaining an appropriate temperature to avoid granulation;
adding the protein-fat hydrosol to an extruder at a temperature between approximately 75° C. and 95° C. to produce a structured protein food product having a fibrous texture similar to that of cooked animal meat.

2. The process of claim 1, wherein the native edestin protein isolate contains substantially no albumin.

3. The process of claim 1, wherein hulled hemp grain is used to produce a substantially white structured protein food product.

4. The process of claim 1, wherein whole hemp grain is used to produce a substantially dark structured food product.

5. The process of claim 1, wherein a mixture of whole hemp grain and hulled hemp grain is used to produce a structured protein food product of intermediate color between light and dark.

6. The process of claim 1, wherein hulls are combined with hulled hemp grain to produce a structured protein food product of intermediate color between light and dark.

7. The process of claim 1, wherein the native edestin protein isolate is pasteurized followed by spray drying at temperatures below 155° F. to avoid protein agglomeration.

8. The process of claim 1, wherein spray dried native edestin protein isolate is combined with preheated water at approximately 145° F. to maintain pasteurizing conditions while forming the protein hydrosol, and wherein an oil is added to the protein hydrosol at temperatures of approximately 145° F. to maintain pasteurizing conditions while forming the protein-fat hydrosol, and wherein the protein-fat hydrosol is added to the extruder while pasteurizing conditions are maintained.

9. The process of claim 1, wherein the protein-fat hydrosol is a liquid when added to the extruder.

10. The process of claim 1, wherein the extruder has a steam-heated auger.
sifting the hemp grain slurry at a mesh size of between 160 and 200 to remove chlorophyll containing particles from the hemp grain slurry without substantially reducing a protein yield;
substantially separating the insoluble material from the soluble material by centrifugal decanting to produce a native edestin protein isolate and an albumin oil aqueous emulsion;
providing water to maintain the native edestin protein isolate is above a solids content of about 20% w/w and mixing to form a protein hydrosol;
pasteurizing the native edestin protein isolate at a temperature below 155° F. to avoid granulation;
combining the native edestin protein isolate with an oil to form a protein-fat hydrosol while maintaining an appropriate temperature to avoid granulation;
adding the protein-fat hydrosol to an extruder at a temperature between approximately 75° C. and 95° C. to produce a structured protein food product having a fibrous texture similar to that of cooked animal meat.
